(19) United States
(12) Patent Application Publication
(10) Pub. No.: US 2026/0126943 A1
(43) Pub. Date: May 7, 2026

(54) ELECTRONIC DEVICE AND METHOD OF OPERATING THE ELECTRONIC DEVICE

(71) Applicant: SAMSUNG ELECTRONICS CO., LTD., Suwon-si (KR)

(72) Inventors: Jaeryong HAN, Suwon-si (KR); Nuri HA, Suwon-si (KR)

(73) Assignee: SAMSUNG ELECTRONICS CO., LTD., Suwon-si (KR)

(21) Appl. No.: 19/439,964

(22) Filed: Jan. 5, 2026

Related U.S. Application Data
(63) Continuation of application No. PCT/KR2025/011347, filed on Jul. 30, 2025.

(30) Foreign Application Priority Data
Jul. 30, 2024 (KR) 10-2024-0101124

(51) Int. Cl. G06F 3/14; G09G 3/20

(52) U.S. Cl. CPC G06F 3/1446; G09G 3/2096; G09G 2320/0257; G09G 2320/06

(57) ABSTRACT

An electronic device may control a communication interface to receive, from each of a plurality of display devices, information related to a pixel shift operation of the plurality of display devices, obtain information about an initial location of a screen and a movement of the screen to be displayed on each of the plurality of display devices, based on the information related to the pixel shift operation of each of the plurality of display devices, and control the communication interface to transmit, to each of the plurality of display devices, the information about the initial location of the screen and the movement of the screen to control each of the plurality of display devices to perform the pixel shift operation based on the initial location of the screen and the movement of the screen.

### CROSS-REFERENCE TO RELATED APPLICATIONS

This application is a continuation of International Application No. PCT/KR2025/011347, filed on July 30, 2025, which is based on and claims priority to Korean Patent Application No. 10-2024-0101124, filed on July 30, 2024, the disclosures of which are incorporated by reference herein in their entireties.

### TECHNICAL FIELD

One or more embodiments relate to an electronic device and a method of operating the electronic device, and more particularly to, an electronic device capable of preventing an afterimage of a display device, and a method of operating the electronic device.

### BACKGROUND ART

When display devices display the same image at the same location for a long time, afterimages may occur. In particular, in the case of organic light emitting diode (OLED) display devices, afterimages easily occur, and various afterimage prevention technologies may be used to solve this problem. For example, pixel shift may be used to provide afterimage prevention.

Pixel shift is a technology which moves the location of a screen displayed on a display device by a specific pixel in a specific direction over time, which prevents the same image from being displayed at the same location for a long time, thereby reducing the occurrence of afterimages.

### DISCLOSURE

### TECHNICAL SOLUTION

According to embodiments of the disclosure, an electronic device includes: a communication interface; memory storing one or more instructions; and at least one processor configured to execute the one or more instructions stored in the memory, wherein the one or more instructions, when executed by the at least one processor individually and/or collectively, cause the electronic device to: control the communication interface to receive, from each of a plurality of display devices, information related to a pixel shift operation of the plurality of display devices; obtain information about an initial location of a screen and a movement of the screen to be displayed on each of the plurality of display devices, based on the information related to the pixel shift operation of each of the plurality of display devices; and control the communication interface to transmit, to each of the plurality of display devices, the information about the initial location of the screen and the movement of the screen to control each of the plurality of display devices to perform the pixel shift operation based on the initial location of the screen and the movement of the screen.

The information related to the pixel shift operation of each of the plurality of display devices may include: information about a pixel shift mode indicating one of a minimum distance mode for minimizing a distance between screen display locations of the plurality of display devices and an alignment mode for setting screens to be displayed at a same location on the plurality of display devices; and information about a location of each of the plurality of display devices in a display system configured based on the plurality of display devices.

The one or more instructions, when executed by the at least one processor individually and/or collectively, may cause the electronic device to, based on the pixel shift mode indicating the minimum distance mode, determine the initial location of the screen in each of the plurality of display devices so that a distance between adjacent screens displayed on the plurality of display devices is minimized.

The plurality of display devices may include a first display device and a second display device, and the one or more instructions, when executed by the at least one processor individually and/or collectively, may cause the electronic device to, based on the pixel shift mode indicating the minimum distance mode and the location of the first display device being left and the location of the second display device being right, determine the initial location of the screen as a right end of the first display device, and determine the initial location of the screen as a left end of the second display device.

The plurality of display devices may include a first display device and a second display device, and the one or more instructions, when executed by the at least one processor individually and/or collectively, may cause the electronic device to, based on the pixel shift mode indicating the minimum distance mode and the location of the first display device being top upper and the location of the second display device being bottom, determine the initial location of the screen as a lower end in the first display device, and determine the initial location of the screen as a top end in the second display device.

The one or more instructions, when executed by the at least one processor individually and/or collectively, may cause the electronic device to, based on the pixel shift mode indicating the alignment mode, determine the initial location of the screen in each of the plurality of display devices so that the screens are displayed at a same location on the plurality of display devices.

The one or more instructions, when executed by the at least one processor individually and/or collectively, may cause the electronic device to, based on a mismatch of the pixel shift mode of the plurality of display devices, output a message guiding to set pixel shift modes of the plurality of display devices to be same.

The information about the movement of the screen may include information about a movement direction of the screen and information about a movement range of the screen.

The communication interface may include a wired/wireless communication interface.

The electronic device may be provided in one of the plurality of display devices.

According to embodiments of the disclosure, a method of operating an electronic device, includes: receiving, from each of a plurality of display devices, information related to a pixel shift operation of the plurality of display devices, based on the information related to the pixel shift operation of each of the plurality of display devices, obtaining information about an initial location of a screen and a movement of the screen to be displayed on each of the plurality of display devices, and transmitting, to each of the plurality of display devices, the information about the initial location of the screen and the movement of the screen to control each of the plurality of display

devices to perform the pixel shift operation based on the initial location of the screen and the movement of the screen.

The information related to the pixel shift operation of each of the plurality of display devices may include: information about a pixel shift mode indicating one of a minimum distance mode for minimizing a distance between screen display locations of the plurality of display devices and an alignment mode for setting screens to be displayed at a same location on the plurality of display devices; and information about a location of each of the plurality of display devices in a display system configured based on the plurality of display devices.

The method may further include, based on the pixel shift mode indicating the minimum distance mode, determining the initial location of the screen in each of the plurality of display devices so that a distance between adjacent screens displayed on the plurality of display devices is minimized.

The plurality of display devices may include a first display device and a second display device, and the method may further include, based on the pixel shift mode indicating the minimum distance mode and the location of the first display device being left and the location of the second display device being right, determining the initial location of the screen as a right end of the first display device, and determining the initial location of the screen as a left end of the second display device.

The plurality of display devices may include a first display device and a second display device, and the method may further include, based on the pixel shift mode indicating the minimum distance mode and the location of the first display device being bottom, determining the initial location of the screen as a lower end in the first display device, and determining the initial location of the screen as a top end in the second display device.

The method may further include, based on the pixel shift mode indicating the alignment mode, determining the initial location of the screen in each of the plurality of display devices so that the screens are displayed at a same location on the plurality of display devices.

The method may further include, based on a mismatch of the pixel shift mode of the plurality of display devices, outputting a message guiding to set pixel shift modes of the plurality of display devices to be same.

The information about the movement of the screen may include information about a movement direction of the screen and information about a movement range of the screen.

According to embodiments of the disclosure, a non-transitory computer-readable recording medium storing therein one or more instructions executable by at least one processor of an electronic device, wherein the one or more instructions, when executed by the at least one processor of the electronic device, cause the electronic device to: control a communication interface to receive, from each of a plurality of display devices, information related to a pixel shift operation of the plurality of display devices; obtain information about an initial location of a screen and a movement of the screen to be displayed on each of the plurality of display devices, based on the information related to the pixel shift operation of each of the plurality of display devices; and control the communication interface to transmit, to each of the plurality of display devices, the information about the initial location of the screen and the movement of the screen to control each of the plurality of display devices to perform the pixel shift operation based on the initial location of the screen and the movement of the screen.

### DESCRIPTION OF DRAWINGS

The above and other aspects, features and advantages of certain embodiments of the present disclosure will be more apparent from the following description taken in conjunction with the accompanying drawings, in which:

FIG. 1 is a reference diagram for explaining a pixel shift operation used in a display device.

FIG. 2 is a reference diagram for explaining a pixel shift operation in a multi-display environment.

FIG. 3 is a diagram illustrating a multi-display system according to an embodiment.

FIG. 4 illustrates an example of a system including a first display device, a second display device, and an electronic device, according to an embodiment.

FIG. 5 illustrates an example of a system including a first display device and a second display device, according to an embodiment.

FIG. 6 illustrates an example in which an electronic device and a first display device are connected to each other using wired communication, according to an embodiment.

FIG. 7 illustrates an example of a flowchart of a method of operating a first display device, according to an embodiment.

FIG. 8 illustrates an example of a graphic user interface capable of setting information related to a pixel shift operation, according to an embodiment.

FIG. 9 is a reference diagram for explaining an example of a minimum distance mode according to an embodiment.

FIG. 10 is a reference diagram for explaining an example of an alignment mode according to an embodiment.

FIG. 11 illustrates an example of a flowchart of a method of operating an electronic device, according to an embodiment.

FIG. 12 is a reference diagram for explaining a pixel shift operation when two display devices are arranged horizontally side by side, according to an embodiment.

FIG. 13 is a reference diagram for explaining a pixel shift operation when two display devices are vertically arranged, according to an embodiment.

FIG. 14 is a reference diagram for explaining a pixel shift operation when two display devices are arranged horizontally side by side, according to an embodiment.

FIG. 15 illustrates an example of a flowchart of a method of operating an electronic device according to an embodiment.

FIG. 16 illustrates an example of a method, performed by an electronic device, of obtaining pixel shift control information, according to an embodiment.

FIG. 17 illustrates an example of a guide message according to an embodiment.

FIG. 18 illustrates an example of a guide message according to an embodiment.

FIG. 19 illustrates an example of a flowchart of a method of operating an electronic device, according to an embodiment.

FIG. 20 is a reference diagram for explaining a pixel shift operation when one display device is powered on, according to an embodiment.

FIG. 21 is a reference diagram for explaining a pixel shift operation when one display device is powered on, according to an embodiment.

### MODE FOR INVENTION

Terms used herein will be briefly described and then the disclosure will be described in detail.

The terms used herein are those general terms currently widely used in the art in consideration of functions in the disclosure, but the terms may vary according to the intentions of one of ordinary skill in the art, precedents, or new technology in the art. In addition, in some cases, there may be terms that are optionally selected by the applicant, and the meanings thereof will be described in detail in the corresponding portions of the disclosure. Thus, the terms used herein should be understood not as simple names but based on the meanings of the terms and the overall description of the disclosure.

Throughout the specification, when a part is referred to as “including” a structural element, this means that the part may further include other structural elements rather than excluding other structural elements unless otherwise specified. In addition, as used herein, the terms such as “unit” and “module” may refer to units that perform at least one function or operation, and the unit may be implemented as hardware or software or a combination of hardware and software.

As used herein, the terms “1st” or “first” and “2nd” or “second” may use corresponding components regardless of importance or order and are used to distinguish a component from another component without limiting the components.

Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Embodiments will be described more fully hereinafter with reference to the accompanying drawings so that embodiments may be easily implemented by one of ordinary skill in the art. However, the disclosure may be implemented in different forms and should not be construed as being limited to an embodiment set forth herein. In addition, portions irrelevant to the description of the disclosure will be omitted in the drawings for a clear description of the disclosure, and like reference numerals will denote like structural elements throughout the specification.

As used herein, the term “user” may refer to a person controlling a function or operation of a computing device or an electronic device by using a control device and may include a viewer, a manager, or an installer.

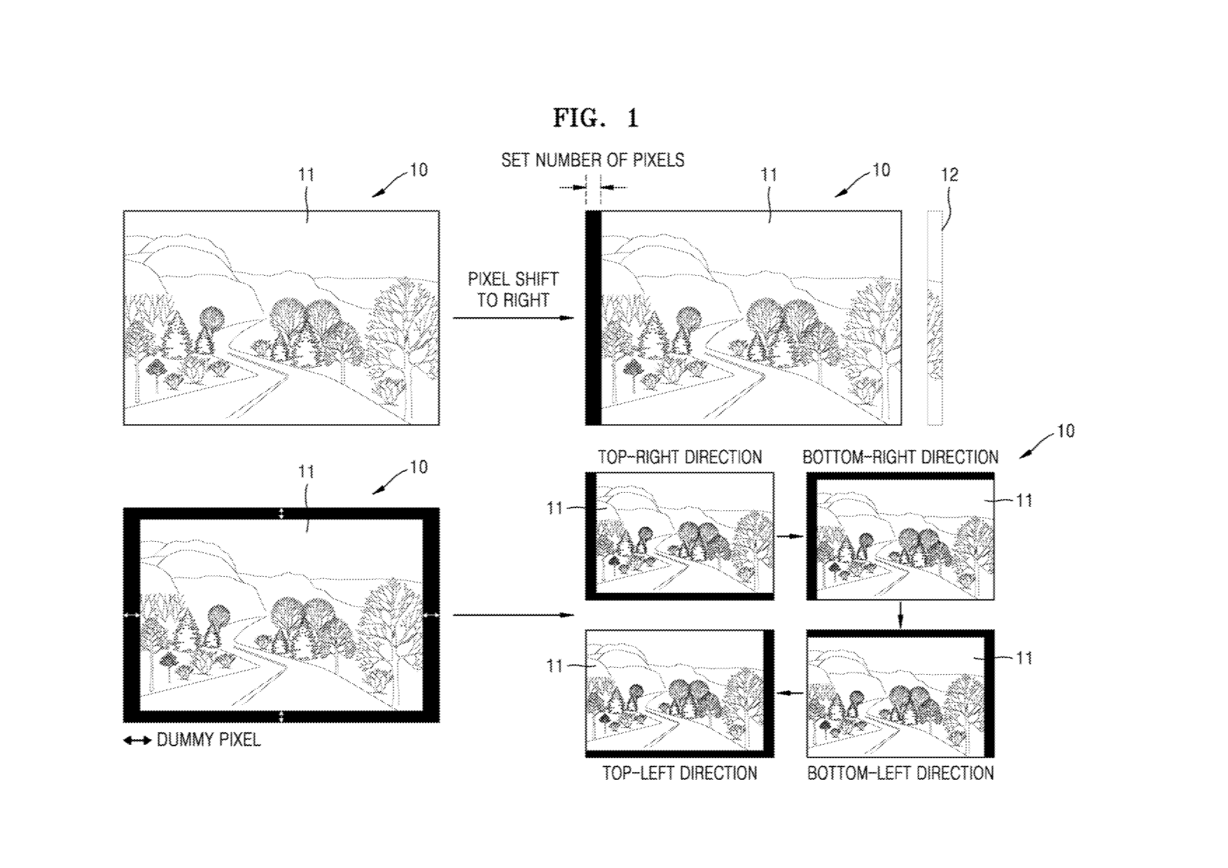

FIG. 1 is a reference diagram for explaining a pixel shift operation used in a display device 10.

Referring to FIG. 1, when the display device 10 displays an image 11 at the same location for a long time, to avoid an afterimage phenomenon, the display device 10 may perform the pixel shift operation. For example, when the display device 10 performs the pixel shift operation on the image 11 to the right, the image 11 may be displayed by being moved to the right by a set number of pixels in the display device 10. In the pixel shift operation, a left part of the image 11 begins to be displayed at a position spaced by a set number of pixels from a left edge of the screen of the display device 10, and, a right part of the image 11, corresponding to the set number of pixels, may be cut off and not displayed beyond the screen boundary.

Therefore, to prevent the image 11 from being cut off by the pixel shift operation, the display device 10 may prevent the image 11 from being cut off even though the display location of the image 11 is moved by providing dummy pixels on the top, bottom, left, and right of the screen. As described above, when the dummy pixels are provided on the top, bottom, left, and right of the screen, the display device 10 may prevent an afterimage phenomenon and prevent the image 11 from being cut off while sequentially moving and displaying the image 11 in a top-right direction (i.e., toward an upper right corner), a bottom-right direction (i.e., toward a lower right corner), a bottom-left direction (i.e., toward a lower left corner), and a top-left direction (i.e., toward a top left corner).

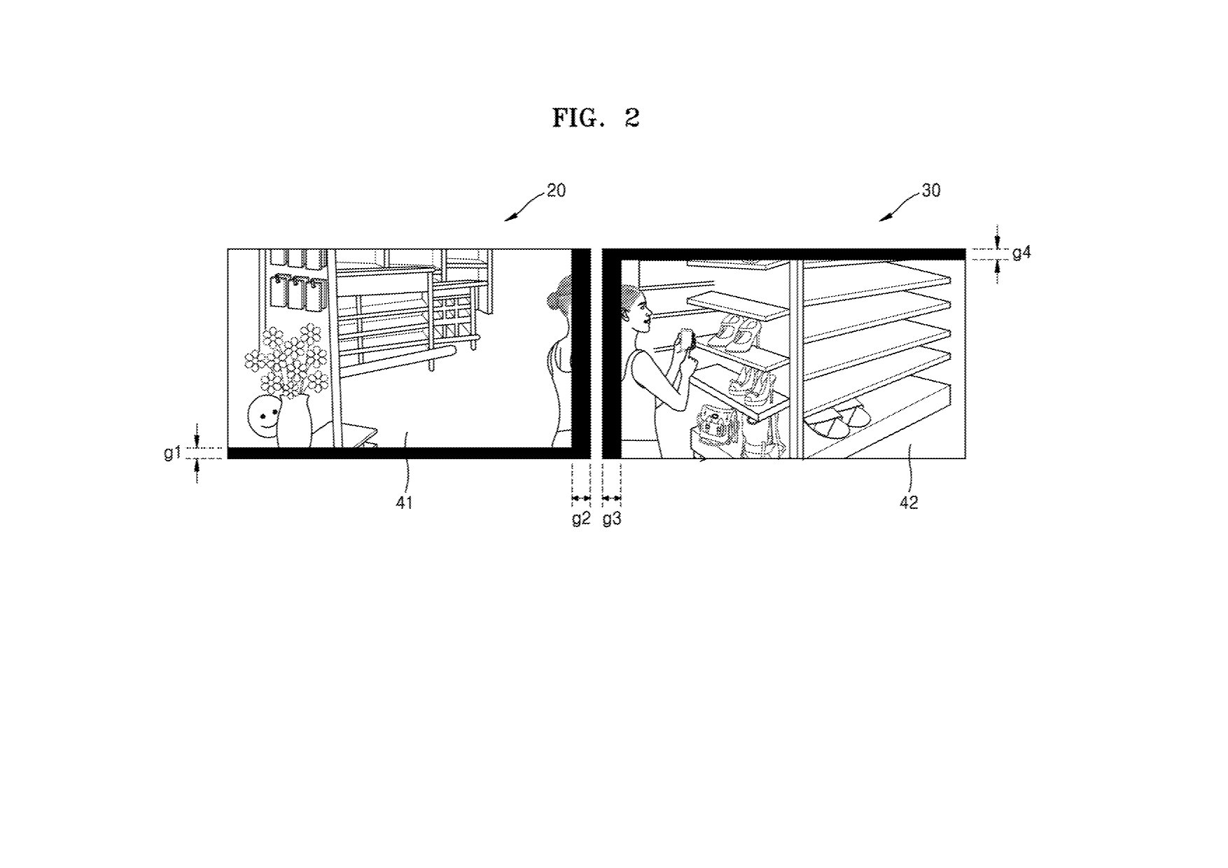

FIG. 2 is a reference diagram for explaining a pixel shift operation in a multi-display environment.

The multi-display environment or a multi-display system refers to displaying an image using two or more display devices. The multi-display system connects a plurality of display devices to display an image, thereby making it possible to display the image on a larger screen. For example, dual monitors may be used at home or in the office, or such a multi-display system may be used for indoor or outdoor billboards for commercial purposes. The multi-display system may include various structures, such as two display devices arranged horizontally, two display devices arranged vertically, or four display devices arranged in a 2x2 form (i.e., two rows and two columns).

Referring to FIG. 2, the multi-display system in which two display devices 20 and 30 are arranged horizontally is shown. At this time, each of the display devices 20 and the display device 30 operates according to a pixel shift function set by itself. For example, the display devices 20 and the display device 30 may independently perform the pixel shift function set. Accordingly, when dummy pixels are provided on the top, bottom, left, and right of a screen according to the setting of the display device 20, the display device 20 may move and display an image 41 in a top-right direction, a bottom-right direction, a bottom-left direction, and a top-left direction. In addition, when dummy pixels are provided on the up, down, left, and right of a screen according to the setting of the display device 30, the display device 30 may also move and display an image 42 in the top-right direction, the bottom-right direction, the bottom-left direction, and the top-left direction. Because the display device 20 and the display device 30 independently perform a pixel shift operation according to their respective settings, the image 41 displayed on the display device 20 and the image 42 displayed on the display device 30 may be displayed by determining an initial display location, a pixel shift movement direction, and a pixel shift movement range. Therefore, for example, as shown in FIG. 2, when the display device 20 displays the image 41 in the top-left direction, the display device 30 may display the image 42 in the bottom-right direction. Therefore, gaps g2 and g3 between the image 41 and the image 42 makes the arrangement between the display devices 20 and 30 appear distant, eventually giving the impression of a thick bezel. In addition, the image 41 has a gap g1 at the bottom of the screen, while the image 42 has a gap g4 at the top of the screen, which may lead to unnatural alignment of image display locations and inconsistent screen movement times. As described above, the pixel shift operation does not operate organically but operates independently in each of the display devices 20 and 30, which may greatly degrade a user experience of a user who uses a plurality of display devices.

Accordingly, the disclosure provides an electronic device enabling a plurality of display devices to operate organically by sharing information about pixel shift of each display device when pixel shift operates in the plurality of display devices, thereby preventing degradation of user experience of images displayed on the plurality of display devices, and a method of operating the electronic device.

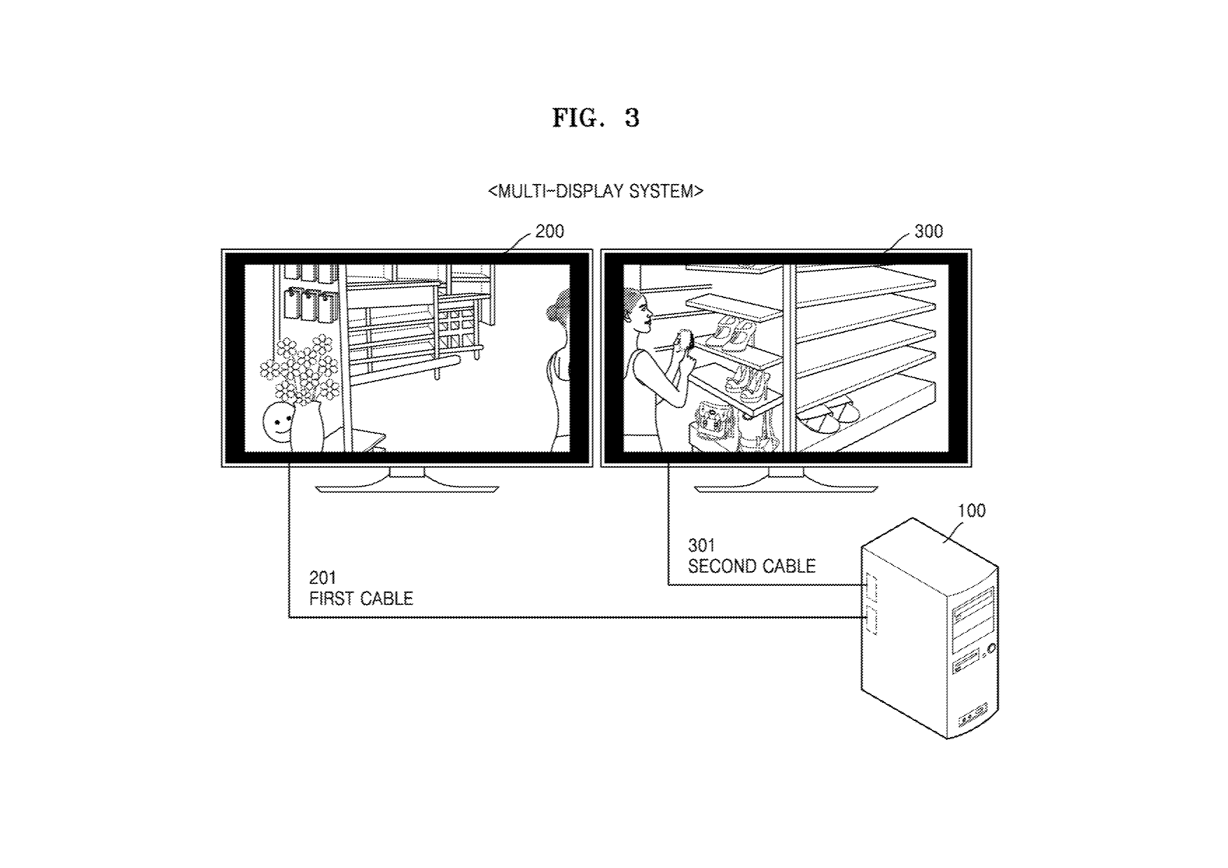

FIG. 3 is a diagram illustrating a multi-display system according to an embodiment.

Referring to FIG. 3, the multi-display system may include an electronic device 100, a first display device 200, and a second display device 300.

The electronic device 100 may provide content, such as video and audio, to the first display device 200 and the second display device 300. The electronic device 100 may include various types of electronic devices capable of providing content to the first display device 200 and the second display device 300, such as a set-top box, a digital video disc (DVD) player, a Blu-ray disc player, a personal computer (PC), game machine, etc. The electronic device 100 may be referred to as a source device in terms of providing content, or may be referred to as a host device, a content providing device, a computing device, etc.

Each of the first display device 200 and the second display device 300 may display content received from the electronic device 100 on a screen.

The first display device 200 and the second display device 300 may include various types of electronic devices capable of receiving and outputting content, such as a network television (TV), a smart TV, an Internet TV, a web TV, an Internet protocol television (IPTV), a PC, etc. Each of the first display device 200 and the second display device 300 may be referred to as a display device in terms of receiving and displaying content, and may also be referred to as a content receiving device, a sink device, an electronic device, a computing device, etc. Alternatively, the electronic device 100 may be referred to as a primary device, and the display devices 200 and 300 may be referred to as secondary devices.

The electronic device 100, the first display device 200, and the second display device 300 may be connected to each other through various types of communication interfaces or video transmission interfaces to transmit and receive content. A video transmission interface may be implemented as, for example, a cable, and each of the electronic device 100, the first display device 200, and the second display device 300 may include one or more signal input/output ports for cable connection. Referring to FIG. 3, for example, the electronic device 100 and the first display device 200 are connected to each other through a first cable 201, and the electronic device 100 and the second display device 300 are connected to each other through a second cable 301. The video transmission interface may include, for example, a D-subminiature (D-SUB), a digital visual interface (DVI), high definition multimedia interface (HDMI), a display port, and a Universal Serial Bus (USB) Type-C. According to the type of the video transmission interface, video signals exchanged between the electronic device 100, the first display device 200, and the second display device 300 may be different.

The one or more signal input/output ports may transmit or receive video signals corresponding to the standard of the connected video transmission interface.

For example, the electronic device 100, the first display device 200, and the second display device 300 may be connected to each other through a video transmission interface implemented as an HDMI cable, and may transmit and receive HDMI video signals through HDMI ports provided in the electronic device 100, the first display device 200, and the second display device 300, respectively. The electronic device 100 may transmit an HDMI video signal corresponding to the HDMI standard to each of the first display device 200 and the second display device 300, and each of the first display device 200 and the second display device 300 may receive the HDMI video signal from the electronic device 100. For example, the electronic device 100, the first display device 200, and the second display device 300 may be connected to each other through a video transmission interface implemented as a display port cable, and may transmit and receive display port video signals through display ports provided in the electronic device 100, the first display device 200, and the second display device 300, respectively.

In the multi-display environment shown in FIG. 3, one electronic device 100 is connected to a plurality of display devices so that each display device receives one of a plurality of video signals from the electronic device 100 and displays the video signal on the screen.

The first display device 200 and the second display device 300 may be connected to one electronic device 100 through different cables. For example, the first display device 200 may be connected to the input/output port of the electronic device 100 through the first cable 201. The second display device 300 may be connected to the input/output port of the electronic device 100 through the second cable 301. Each of the first cable 201 and the second cable 301 may be, for example, any one of a D-SUB cable, a DVI cable, an HDMI cable, a display port cable, and a USB Type-C cable.

The first display device 200 and the second display device 300 may receive a first video signal from the electronic device 100 through the first cable 201 and display a first video, and the second display device 300 may receive a second video signal from the electronic device 100 through the second cable 301 and display a second video. The first cable 201 and the second cable 301 may be the same type of video transmission interface or different types of video transmission interfaces.

According to an embodiment, the first display device 200 may store setting information for a pixel shift operation. For example, the first display device 200 may provide a graphic user interface for setting the pixel shift operation and store setting information for the pixel shift operation based on input data received through the graphic user interface. The setting information for the pixel shift operation may include at least one of pixel shift on/off information indicating whether the pixel shift operation is performed, pixel shift mode information indicating a pixel shift mode, or location information of a display device.

According to an embodiment, the second display device 300 may store the setting information for the pixel shift operation. For example, the second display device 300 may provide a graphic user interface for setting the pixel shift operation and store setting information for the pixel shift operation (hereinafter referred to as pixel shift setting information) according to input data received through the graphic user interface or from another device, such as the electronic device 100. The setting information for the pixel shift operation may include at least one of pixel shift on/off information indicating whether the pixel shift operation is performed, pixel shift mode information indicating a pixel shift mode, or location information of a display device.

According to an embodiment, the first display device 200 and the second display device 300 may provide the respective setting information for the pixel shift operation to the electronic device 100. For example, when the first display device 200 and the second display device 300 are powered on or released from a power saving mode and switched to a normal mode, the first display device 200 and the second display device 300 may provide the respective setting information for the pixel shift operation to the electronic device 100.

According to an embodiment, the electronic device 100 may receive the setting information for the pixel shift operation from the first display device 200 and the second display device 300.

According to an embodiment, the electronic device 100 may obtain control information for the pixel shift operation (hereinafter, referred to as pixel shift control information) based on the setting information for the pixel shift operation received from the first display device 200 and the setting information for the pixel shift operation received from the second display device 300. The control information for the pixel shift operation may include at least one of information about an initial location of the screen, information about a pixel shift movement direction, or information about a pixel shift movement range.

According to an embodiment, the electronic device 100 may transmit the control information for the pixel shift operation to each of the first display device 200 and the second display device 300.

According to an embodiment, each of the first display device 200 and the second display device 300 may perform the pixel shift operation based on the control information for the pixel shift operation received from the electronic device 100.

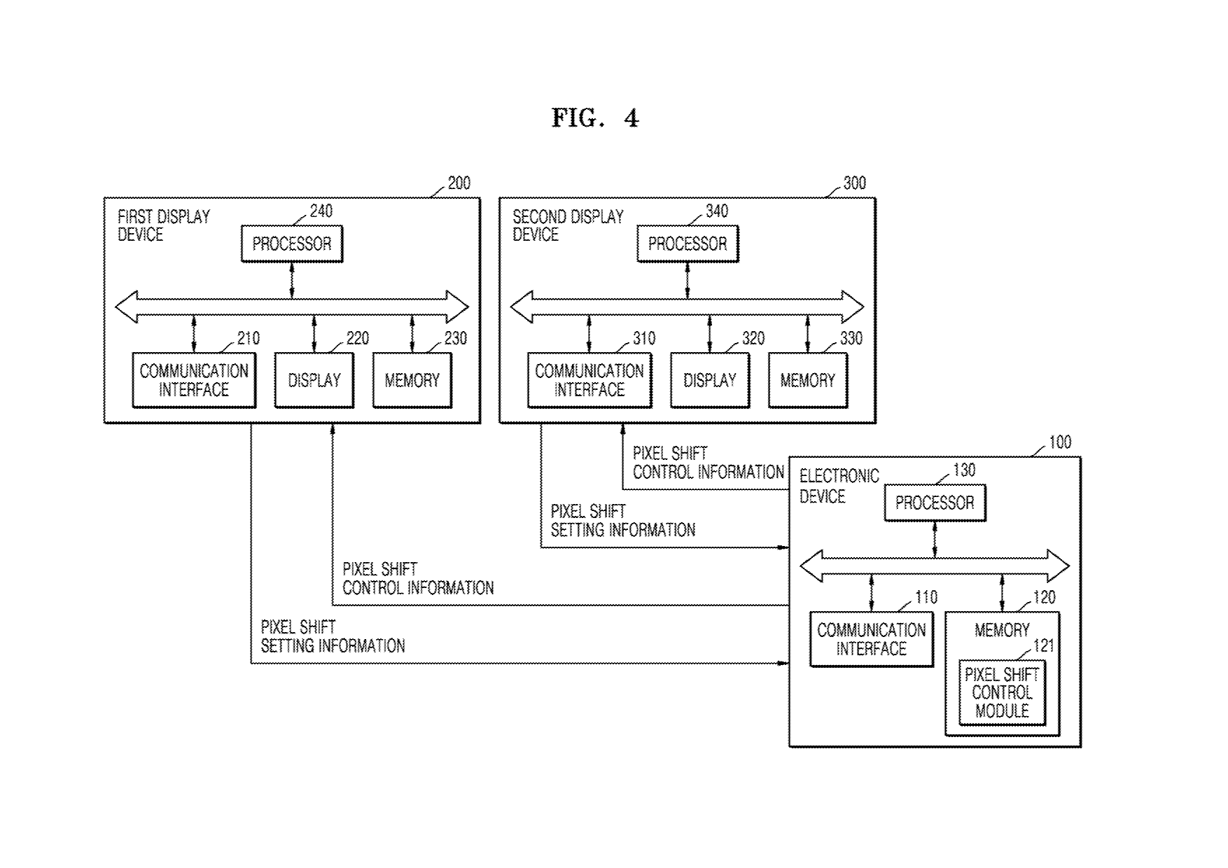

FIG. 4 illustrates an example of a system including the first display device 200, the second display device 300, and the electronic device 100 according to an embodiment.

Referring to FIG. 4, each of the first display device 200 and the second display device 300 may be connected to the electronic device 100.

The first display device 200, which is a device capable of displaying images or data, may include a communication interface 210, a display 220, a memory 230, and a processor 240.

The communication interface 210 may include various communication circuits for performing communication with at least one external device. Here, ‘communication’ may indicate an operation of transmitting and/or receiving data, signals, requests, and/or commands. Hereinafter, the at least one external device will be described as the electronic device 100 as an example.

The communication interface 210 may perform wired or wireless communication with the electronic device 100.

For example, the communication interface 210 may include at least one of a communication module, a communication circuit, a communication device, an input/output port, or an input/output plug for performing wired communication with the electronic device 100.

For example, the communication interface 210 may include at least one wireless communication module, wireless communication circuit, or wireless communication device that performs wireless communication with the electronic device 100.

For example, the communication interface 210 may include a short-range communication module capable of receiving control commands from an input device, such as a remote controller located at a short distance, and the short-range communication module may include an infrared (IR) communication module, etc. In this case, the communication interface 210 may receive a control signal from the remote controller.

For example, the communication interface 210 may include at least one communication module that performs communication according to wireless communication standards such as Bluetooth, Wi-Fi, Bluetooth Low Energy (BLE), NFC/RFID, Wi-Fi Direct, Ultra-Wideband(UWB) or ZIGBEE. Alternatively, the communication interface 210 may further include a communication module that performs communication with a server for supporting long-range communication according to the long-range communication standard. For example, the communication interface 210 may include a communication module that performs communication via a network for Internet communication. In addition, the communication interface 210 may include a communication module that performs communication via a communication network according to communication standards such as 3G, 4G, 5G, and/or 6G.

For example, in order to communicate with the electronic device 100 through a wired connection, the communication interface 210 may include at least one port for connecting to the electronic device 100 through a wired cable. For example, the communication interface 210 may include at least one of an HDMI port, a component jack, a PC port, a display port, or a USB port. Accordingly, the communication interface 210 may communicate with the electronic device 100 connected by wire through the at least one port. Here, the port may refer to a physical device component capable of connecting or inserting a cable, a communication line, or a plug.

As described above, the communication interface 210 may include at least one support element for supporting communication between the first display device 200 and the electronic device 100. Here, the support element may include the above-described communication module, communication circuit, communication device, port (for input/output of data), cable port (for input/output of data), plug (for input/output of data), etc. For example, at least one support element included in the communication interface 210 may include an Ethernet communication module, a Wi-Fi communication module, a Bluetooth communication module, an IR communication module, a USB port, a tuner (or broadcast receiver), an HDMI port, a display port (DP), a DVI port, etc.

The display 220 may output images or data processed by the first display device 200.

The memory 230 may store a program for processing and controlling by the processor 240, and may store data that is input to or output from the first display device 200. In addition, the memory 230 may store data necessary for the operation of the first display device 200.

The memory 230 may include at least one type of storage medium from among flash memory type, hard disk type, multimedia card micro type, card type memory (e.g., an Secure Digital (SD) or Extreme Digital (xD) memory), random- access memory (RAM), static random-access memory (SRAM), read-only memory (ROM), electronically erasable programmable read-only memory (EEPROM), programmable read-only memory (PROM), magnetic memory, magnetic disk, or optical disk.

The processor 240 controls the overall operation of the first display device 200. For example, the processor 240 may perform the function of the first display device 200 described herein by executing one or more instructions stored in the memory 230.

The processor 240 may include various processing circuits and/or a plurality of processors. For example, the term “processor” used herein, including the claims, may include various processing circuits, including at least one processor. In at least one processor, one or more processors may be configured to perform the various functions described herein, individually and/or collectively in a distributed form. As used herein, “processor”, “at least one processor”, and “one or more processors” may be configured to perform various functions. However, these terms cover, for example, situations, but without limitation, where one processor performs some of the functions and another processor(s) performs the others of the functions, and a situation where a single processor perform all of the functions. In addition, at least one processor may include a combination of processors that perform various functions disclosed in a distributed manner. At least one processor may execute program instructions to achieve or perform various functions.

In an embodiment, the processor 240 may store one or more instructions in an internally provided memory and execute the one or more instructions stored in the internally provided memory to control operations of a display device to be performed. That is, the processor 240 may perform a specified operation by executing at least one instruction or program stored in the internal memory of the processor 240 or the memory 230.

According to an embodiment, the processor 240 may control the operation of the first display device 200 disclosed herein by executing the one or more instructions stored in the memory 230.

According to an embodiment, the at least one processor 240 may provide a graphic user interface for setting a pixel shift operation and store setting information for the pixel shift operation in the memory 230 according to a user input received through the graphic user interface by executing the one or more instructions stored in the memory 230. The setting information for the pixel shift operation may include at least one of pixel shift on/off information indicating whether the pixel shift operation is performed, pixel shift mode information indicating a pixel shift mode, or location information of a display device. The setting information for the pixel shift operation may be referred to as pixel shift setting information.

According to an embodiment, the at least one processor 240 may control the communication interface 210 to transmit the pixel shift setting information to the electronic device 100 by executing the one or more instructions stored in the memory 230. For example, the at least one processor 240 may control the communication interface 210 to transmit the pixel shift setting information to electronic device 100 when the first display device 200 is powered on or switched from a low power mode to a normal mode by executing the one or more instructions stored in memory 230.

According to an embodiment, the at least one processor 240 may receive the pixel shift control information in response to transmitting the pixel shift setting information to the electronic device 100 by executing the one or more instructions stored in the memory 230. For example, the pixel shift setting information may include at least one of an initial location of the screen, a pixel shift movement direction, or a pixel shift movement range.

According to an embodiment, the at least one processor 240 may perform the pixel shift operation based on the pixel shift control information received from the electronic device 100 by executing the one or more instructions stored in the memory 230. For example, the at least one processor 240 may control the display 220 to display an image according to the initial location of the screen indicated by the pixel shift setting information and to move the image according to the pixel shift movement direction and the pixel shift movement range.

The first display device 200 may be any type of device that includes a processor and a memory to perform a function. The first display device 200 may be a fixed or portable device. For example, the first display device 200 may refer to a device that includes a display to display image content, video content, game content, graphic content, etc. The first display device 200 may include, for example, various types of electronic devices capable of receiving and outputting content, such as television including a network TV, a smart TV, an Internet TV, a Web TV, an IPTV, a computer including a desktop, a laptop, a tablet, and various smart devices including a smart phone, a cellular phone, a game player, a music player, a video player, a medical device, a home appliance, etc.

A block diagram of the first display device 200 shown in FIG. 4 is provided as an example. Structural elements of the block diagram may be integrated, added, or omitted according to the specifications of the first display device 200 that is actually implemented. For example, when necessary, two or more structural elements may be combined into one structural element, or one structural element may be subdivided into two or more structural elements. In addition, a function performed by each block is for explaining embodiments, and a specific operation or device does not limit the scope of the disclosure.

The second display device 300, which is a device capable of displaying images or data, and may include a communication interface 310, a display 320, a memory 330, and a processor 340.

The communication interface 310 may include various communication circuits for performing communication with at least one external device. Here, ‘communication’ may indicate an operation of transmitting and/or receiving data, signals, requests, and/or commands. Hereinafter, the at least one external device will be described as the electronic device 100 as an example.

The communication interface 310 may perform wired or wireless communication with the electronic device 100.

For example, the communication interface 310 may include at least one of a communication module, a communication circuit, a communication device, an input/output port, or an input/output plug for performing wired communication with the electronic device 100.

For example, the communication interface 310 may include at least one wireless communication module, wireless communication circuit, or wireless communication device that performs wireless communication with the electronic device 100.

For example, the communication interface 310 may include a short-range communication module capable of receiving control commands from an input device, such as a remote controller located at a short distance, and the short-range communication module may include IR communication module, etc. In this case, the communication interface 310 may receive a control signal from the remote controller.

For example, the communication interface 310 may include at least one communication module that performs communication according to wireless communication standards such as Bluetooth, Wi-Fi, Bluetooth Low Energy (BLE), Near Field Communication (NFC), Radio Frequency Identification (RFID) Wi-Fi Direct, UWB, or ZIGBEE. Alternatively, the communication interface 310 may further include a communication module that performs communication with a server for supporting long-range communication according to the long-range communication standard. For example, the communication interface 310 may include a communication module that performs communication via a network for Internet communication. In addition, the communication interface 310 may include a communication module that performs communication via a communication network according to communication standards such as 3G, 4G, 5G, and/or 6G.

For example, in order to communicate with the electronic device 100 through a wired connection, the communication interface 310 may include at least one port for connecting to the electronic device 100 through a wired cable. For example, the communication interface 310 may include at least one of an HDMI port, a component jack, a PC port, a display port, or a USB port. Accordingly, the communication interface 210 may communicate with the electronic device 100 connected by wire through the at least one port. Here, the port may refer to a physical device component capable of connecting or inserting a cable, a communication line, or a plug.

As described above, the communication interface 310 may include at least one support element for supporting communication between the second display device 300 and the electronic device 100. Here, the support element may include the above-described communication module, communication circuit, communication device, port (for input/output of data), cable port (for input/output of data), plug (for input/output of data), etc. For example, at least one support element included in the communication interface 310 may include an Ethernet communication module, a Wi-Fi communication module, a Bluetooth communication module, an IR communication module, a USB port, a tuner (or broadcast receiver), an HDMI port, a DP, a DVI port, etc.

The display 320 may output images or data processed by the first display device 200.

The memory 330 may store a program for processing and controlling by the processor 340, and may store data that is input to or output from the second display device 300. In addition, the memory 330 may store data necessary for the operation of the second display device 300.

The memory 330 may include at least one type of storage medium from among flash memory type, hard disk type, multimedia card micro type, card type memory (e.g., an SD or xD memory), RAM, SRAM, ROM, EEPROM, PROM, magnetic memory, magnetic disk, or optical disk.

The processor 340 controls the overall operation of the second display device 300. For example, the processor 340 may perform the function of the second display device 300 described herein by executing one or more instructions stored in the memory 330.

The processor 340 may include various processing circuits and/or a plurality of processors.

In an embodiment, the processor 340 may store one or more instructions in an internally provided memory and execute the one or more instructions stored in the internally provided memory to control operations of a display device to be performed. That is, the processor 340 may perform a specified operation by executing at least one instruction or program stored in the internal memory of the processor 340 or the memory 330.

According to an embodiment, the processor 340 may control the operation of the second display device 300 disclosed herein by executing the one or more instructions stored in the memory 330.

According to an embodiment, the at least one processor 340 may provide a graphic user interface for setting a pixel shift operation and store setting information for the pixel shift operation in the memory 330 according to a user input received through the graphic user interface by executing the one or more instructions stored in the memory 330. The setting information for the pixel shift operation may include at least one of pixel shift on/off information indicating whether the pixel shift operation is performed, pixel shift mode information indicating a pixel shift mode, or location information of a display device. The setting information for the pixel shift operation may be referred to as pixel shift setting information.

According to an embodiment, the at least one processor 340 may control the communication interface 310 to transmit the pixel shift setting information to the electronic device 100 by executing the one or more instructions stored in the memory 330. For example, at least one processor 340 may control the communication interface 310 to transmit the pixel shift setting information to electronic device 100 when the second display device 300 is powered on or switched from a low power mode to a normal mode by executing the one or more instructions stored in memory 330.

According to an embodiment, the at least one processor 340 may receive the pixel shift control information in response to transmitting the pixel shift setting information to the electronic device 100 by executing the one or more instructions stored in the memory 330. For example, the pixel shift setting information may include at least one of an initial location of the screen, a pixel shift movement direction, or a pixel shift movement range.

According to an embodiment, the at least one processor 340 may perform the pixel shift operation based on the pixel shift control information received from the electronic device 100 by executing the one or more instructions stored in the memory 330. For example, the at least one processor 340 may control the display 320 to display an image according to the initial location of the screen indicated by the pixel shift setting information and to move the image according to the pixel shift movement direction and the pixel shift movement range.

The second display device 300 may be any type of device that includes a processor and a memory to perform a function. The second display device 300 may be a fixed or portable device. For example, the second display device 300 may refer to a device that includes a display to display image content, video content, game content, graphic content, etc. The second display device 300 may include, for example, various types of electronic devices capable of receiving and outputting content, such as television including a network TV, a smart TV, an Internet TV, a Web TV, an IPTV, a computer including a desktop, a laptop, a tablet, and various smart devices including a smart phone, a cellular phone, a game player, a music player, a video player, a medical device, a home appliance, etc.

A block diagram of the second display device 300 shown in FIG. 4 is provided as an example. Structural elements of the block diagram may be integrated, added, or omitted according to the specifications of the second display device 300 that is actually implemented. For example, when necessary, two or more structural elements may be combined into one structural element, or one structural element may be subdivided into two or more structural elements. In addition, a function performed by each block is for explaining embodiments, and a specific operation or device does not limit the scope of the disclosure.

The electronic device 100, which is a device capable of providing an image or data to the first display device 200 or the second display device 300, may include the communication interface 110, a memory 120, and a processor 130.

The communication interface 110 may include various communication circuits for performing communication with at least one external device. Here, ‘communication’ may indicate an operation of transmitting and/or receiving data, signals, requests, and/or commands. Hereinafter, the at least one external device may refer to the first display device 200 or the second display device 300.

The communication interface 110 may perform wired or wireless communication with at least one of the first display device 200 or the second display device 300.

For example, the communication interface 110 may include at least one of a communication module, a communication circuit, a communication device, an input/output port, or an input/output plug for performing wired communication with at least one of the first display device 200 or the second display device 300.

For example, the communication interface 110 may include at least one wireless communication module, wireless communication circuit, or wireless communication device that performs wireless communication with at least one of the first display device 200 or the second display device 300.

For example, the communication interface 110 may include a short-range communication module capable of receiving control commands from an input device, such as a remote controller located at a short distance, and the short-range communication module may include IR communication module, etc. In this case, the communication interface 110 may receive a control signal from the remote controller.

For example, communication interface 110 may include at least one communication module that performs communication according to wireless communication standards such as Bluetooth, Wi-Fi, Bluetooth Low Energy (BLE), NFC/RFID, Wi-Fi Direct, UWB, or ZIGBEE. Alternatively, the communication interface 110 may further include a communication module that performs communication with a server for supporting long-range communication according to the long-range communication standard. For example, the communication interface 110 may include a communication module that performs communication via a network for Internet communication. In addition, communication interface 110 may include a communication module that performs communication via a communication network according to communication standards such as 3G, 4G, 5G, and/or 6G.

For example, in order to communicate with at least one of the first or second display devices 200 or 300 through a wired connection, the communication interface 110 may include at least one port for connecting to at least one of the first display device 200 or the second display device 300 through a wired cable. For example, the communication interface 110 may include at least one of an HDMI port, a component jack, a PC port, a display port, or a USB port. Accordingly, the communication interface 110 may communicate with at least one of the first display device 200 or the second display device 300 connected by wire through the at least one port. Here, the port may refer to a physical device component capable of connecting or inserting a cable, a communication line, or a plug.

As described above, the communication interface 110 may include at least one support element for supporting communication between the second display device 300 and the electronic device 100. Here, the support element may include the above-described communication module, communication circuit, communication device, port (for input/output of data), cable port (for input/output of data), plug (for input/output of data), etc. For example, at least one support element included in the communication interface 110 may include an Ethernet communication module, a Wi-Fi communication module, a Bluetooth communication module, an IR communication module, a USB port, a tuner (or broadcast receiver), an HDMI port, a DP, a DVI port, etc.

The memory 120 may store a program for processing and controlling by the processor 130, and may store data that is input to or output from the electronic device 100. In addition, the memory 120 may store data necessary for the operation of the electronic device 100.

According to an embodiment, the memory 120 may include a pixel shift control module 121 including one or more instructions for obtaining pixel shift control information according to pixel shift setting information.

The memory 120 may include at least one type of storage medium from among flash memory type, hard disk type, multimedia card micro type, card type memory (e.g., an SD or xD memory), RAM, SRAM, ROM, EEPROM, PROM, magnetic memory, magnetic disk, or optical disk.

The processor 130 controls the overall operation of the electronic device 100. For example, processor 130 may perform the function of electronic device 100 described herein by executing one or more instructions stored in memory 120.

The processor 130 may include various processing circuits and/or a plurality of processors.

In an embodiment, the processor 130 may store one or more instructions in an internally provided memory and execute the one or more instructions stored in the internally provided memory to control operations of a display device to be performed. That is, the processor 130 may perform a specified operation by executing at least one instruction or program stored in the internal memory of the processor 130 or the memory 120.

According to an embodiment, the processor 130 may control the operation of the electronic device 100 disclosed herein by executing the one or more instructions stored in the memory 120.

According to an embodiment, the processor 130 may control the communication interface 110 to receive pixel shift setting information from at least one of the first display device 200 or the second display device 300 by executing the one or more instructions stored in the memory 120.

According to an embodiment, the processor 130 may obtain pixel shift control information based on the pixel shift setting information received from at least one of the first display device 200 or the second display device 300 by executing the one or more instructions stored in the memory 120. For example, when the electronic device 100 receives the pixel shift setting information from either the first display device 200 or the second display device 300, the processor 130 may obtain the pixel shift control information for either the first display device 200 or the second display device 300 based on the received pixel shift setting information. For example, when the electronic device 100 receives the pixel shift setting information from the first display device 200 and the second display device 300, the processor 130 may obtain the pixel shift control information for the first display device 200 and the second display device 300 based on the received pixel shift setting information of the first display device 200 and the second display device 300.

According to an embodiment, the at least one processor 130 may control the communication interface 110 to transmit the pixel shift control information to at least one of the first display device 200 or the second display device 300 by executing the one or more instructions stored in the memory 120. For example, when the electronic device 100 receives the pixel shift setting information from the first display device 200 and the second display device 300, the processor 130 may control the communication interface 110 to transmit the obtained pixel shift control information to the first display device 200 and the second display device 300 based on the received pixel shift setting information of the first display device 200 and the second display device 300.

The electronic device 100 may be any type of device that includes a processor and a memory to perform a function. The electronic device 100 may be a fixed or portable device. For example, the electronic device 100 may refer to a device that includes a display to display image content, video content, game content, graphic content, etc. The electronic device 100 may include, for example, various types of electronic devices capable of receiving and outputting content, such as television including a network TV, a smart TV, an Internet TV, a Web TV, an IPTV, a computer including a desktop, a laptop, a tablet, and various smart devices including a smart phone, a cellular phone, a game player, a music player, a video player, a medical device, a home appliance, etc.

A block diagram of the electronic device 100 shown in FIG. 4 is provided as an example. Structural elements of the block diagram may be integrated, added, or omitted according to the specifications of the electronic device 100 that is actually implemented. For example, when necessary, two or more structural elements may be combined into one structural element, or one structural element may be subdivided into two or more structural elements. In addition, a function performed by each block is for explaining embodiments, and a specific operation or device does not limit the scope of the disclosure.

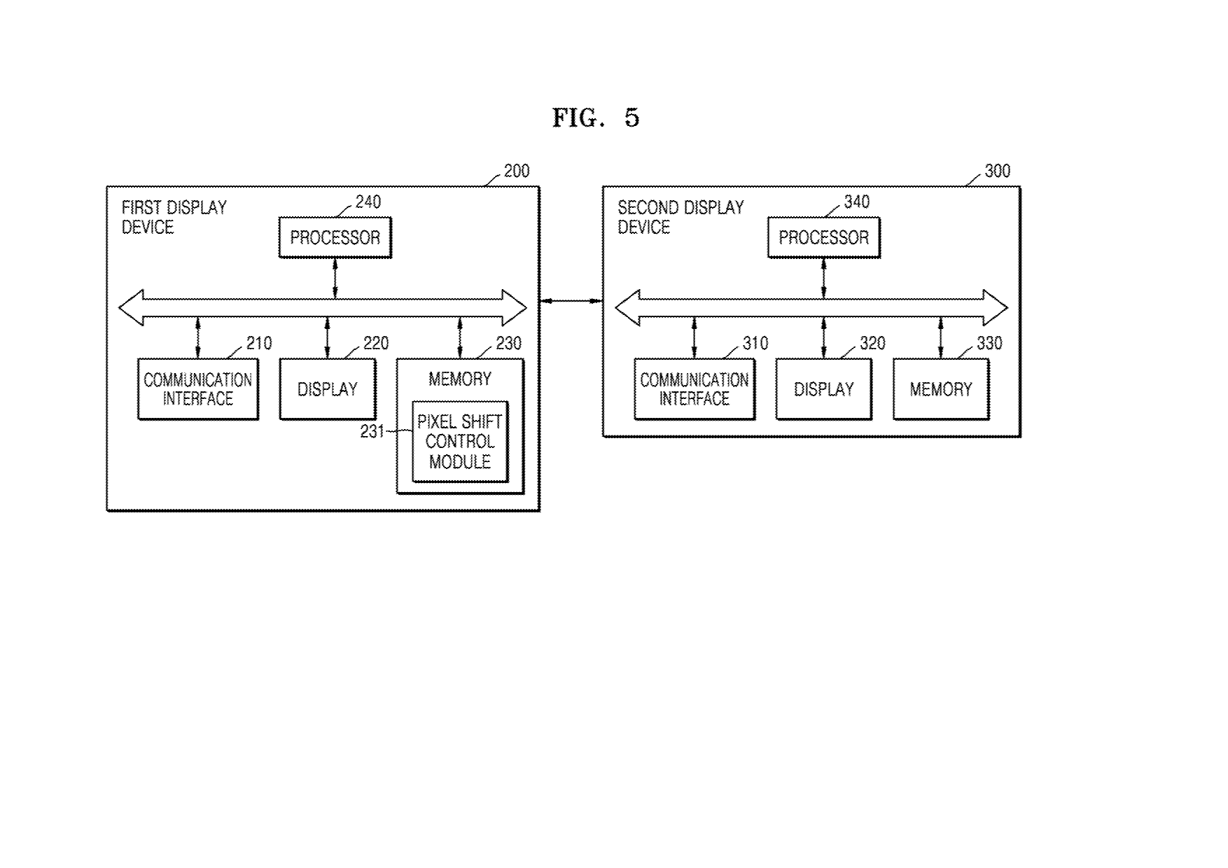

FIG. 5 illustrates an example of a system including the first display device 200 and the second display device 300 according to an embodiment.

FIG. 5 shows an example, in which the first display device 200 controls the pixel shift operation of each of the first display device 200 and the second display device 300.

Referring to FIG. 5, for example, the first display device 200 may include a pixel shift control module 231 in the memory 230.

According to an embodiment, the first display device 200 and the second display device 300 may be communicatively connected to each other.

According to an embodiment, the first display device 200 may receive pixel shift setting information stored in the second display device 300 from the second display device 300.

According to an embodiment, the first display device 200 may obtain pixel shift control information based on pixel shift setting information stored in the first display device 200 and the pixel shift setting information received from the second display device 300.

According to an embodiment, the first display device 200 performs the pixel shift operation of the first display device 200 based on the pixel shift control information and provides the pixel shift control information to the second display device 300 such that the pixel shift operations of the first display device 200 and the second display device 300 may be organically controlled.

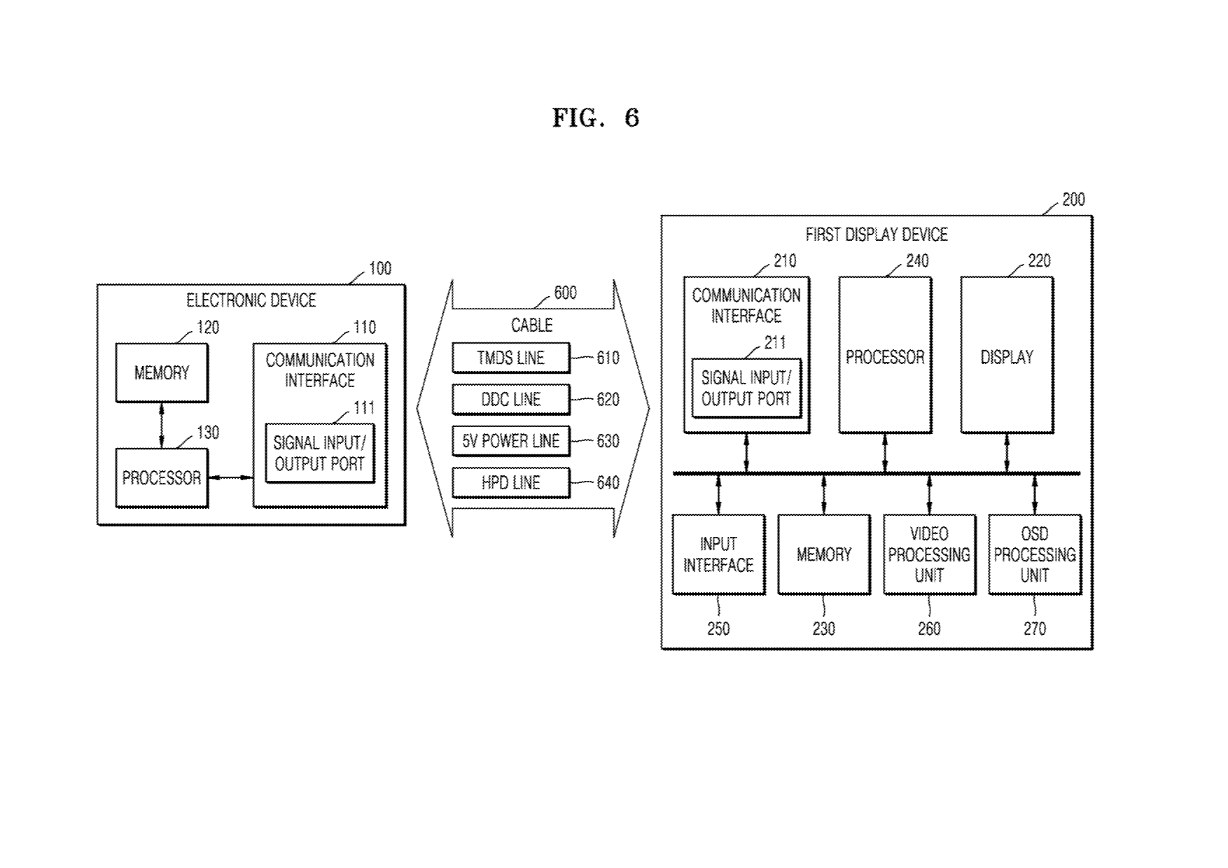

FIG. 6 illustrates an example in which the electronic device 100 and the first display device 200 are connected to each other using wired communication according to an embodiment.

Referring to FIG. 6, the electronic device 100 and the first display device 200 may be connected to each other through, for example, an HDMI cable 600.

Referring to FIG. 6, the HDMI cable 600 may include a transition minimized differential signaling (TMDS) line 610, a display data channel (DDC) line 620, a 5V power line 630, and a hot plug detect (HPD) line 640 for extended display identification data (EDID) read control.

The cable 600 includes the TMDS line 610 that transfers video and audio signals, the DDC line 620 that transfers EDID, the 5V power line 630 that provides a 5-volt voltage from the electronic device 100 to the first display device 200, and the HPD line 640 for EDID read control.

The TMDS line 610 may transfer the video signal received from the electronic device 100 to the first display device 200 according to a TMDS clock signal.

The DDC line 620 refers to a line for serial connection for EDID and HDCP communication. A DDC transmission method defines a communication channel between an electronic device and a display device, and refers to a protocol with respect to a method of transmitting information of the display device stored in the display device to a computer. That is, the DDC line 630 is connected to the processor 240 of the first display device 200 to implement a DDC/command interface (CI) function so that the electronic device 100 may control the function of the first display device 200. For example, a DDC/CI defines a communication channel between, for example, a peripheral device such as a monitor and a PC body, and refers to a communication protocol for transmitting monitor information stored in a monitor to the PC body or changing the monitor information through a keyboard or a mouse. The DDC/CI standard may provide a two-way serial communication link between the monitor and a PC. The processor 130 of the electronic device 100 may issue a command for controlling an internal parameter of the first display device 200 through the DDC/CI. The processor 240 of the first display device 200 may decode a received command according to a DDC/CI protocol to extract a control command to be applied to a display.

The HPD line 640 is a signal line for informing the electronic device 100 of a connection of the first display device 200. The HPD line 640 may output an HPD signal to the electronic device 100. For example, the first display device 200 may transmit an HPD signal having a high level voltage to a signal input/output port 111 of the electronic device 100 through the HPD line 640. The HPD signal informs the electronic device 100 of an event such as unplug, plug/re-plug, booting completion, etc. For example, the signal input/output port 111 of the electronic device 100 may identify that the electronic device 100 and the first display device 200 have been plugged into each other through a high-level HPD signal received through the HPD line 640. For example, the signal input/output port 111 of the electronic device 100 may identify that the electronic device 100 and the first display device 200 have been unplugged from each other through a low-level HPD signal received through the HPD line 640.

With respect to an operation when the electronic device 100 and the first display device 200 are connected to each other through such a connection of the HDMI cable 600, first, when the electronic device 100 and the first display device 200 are connected to each other through the HDMI cable 600, the signal input/output port 111 of the electronic device 100 may provide the 5-volt voltage to a signal input/output port 211 of the first display device 200 through the 5V power line 630. The signal input/output port 211 of the first display device 200 to which the 5-volt voltage has been provided may transmit a signal having a high level voltage to the signal input/output port 111 of the electronic device 100 through the HPD line 640. The signal input/output port 111 of the electronic device 100 that has received the signal having the high level voltage through the HPD line 640 may transmit an EDID request signal through the DDC line 620, and the signal input/output port 211 of the first display device 200 that has received the EDID request signal may provide EDID of the first display device 200 to the signal input/output port 111 of the electronic device 100. The signal input/output port 111 of the electronic device 100 that has received the EDID of the first display device 200 may parse the EDID to obtain display characteristics information and control content processing based on the obtained display characteristics information. The signal input/output port 111 of the electronic device 100 may transmit the video-processed video signal and the audio signal to the signal input/output port 211 of the first display device 200 through the TMDS line 610.

In the example shown in FIG. 6, the cable 600 is described as an HDMI cable, but embodiments are not limited thereto and the cable 600 may include a cable of another specification. When the cable 600 is an HDMI port cable, the pixel shift setting information and the pixel shift control information may be transferred through the DDC line 620.

For example, when the cable 600 is a display port cable, the cable 600 may include a main link for transferring a video signal and an Aux channel used for management of the main link and device control so as to transfer the video signal. When the cable 600 is a display port cable, the pixel shift setting information and the pixel shift control information may be transferred through the Aux channel.

The processor 130 of the electronic device 100 may control to process the video signal to be transmitted to the first display device 200, and control the processed video signal to be output through the communication interface 110.

The communication interface 110 may include at least one signal input/output port. The communication interface 110 may receive EDID including the display characteristics information including information about a supportable resolution, etc. from the first display device 200 through the at least one signal input/output port, and may also output a video signal having a resolution that may be processed by the first display device 200. The communication interface 110 may include, for example, the signal input/output port 111.

The signal input/output port 111 of the electronic device 100 and the signal input/output port 211 of the first display device 200 may be connected to each other through the cable 600. The signal input/output ports 111 and 211 may include signal input/output ports according to various types of communication protocols. For example, the signal input/output port may include ports of various standards such as a HDMI port, a display port (DP), thunderbolt, a mobile high-definition link (MHL), a USB, a DVI port, etc. Hereinafter, a case where the signal input/output port is an HDMI port will be described as an example.

According to an embodiment, the processor 130 may receive the pixel shift setting information of the first display device 200 from the first display device 200 by using the DDC line 620 according to the DDC/CI protocol.

According to an embodiment, the processor 130 may obtain the pixel shift control information based on the pixel shift setting information of the first display device 200. For example, when the electronic device 100 receives the pixel shift setting information only from the first display device 200, the processor 130 may obtain the pixel shift control information for the first display device 200 based on the pixel shift setting information of the first display device 200. For example, when the electronic device 100 receives the pixel shift setting information from the first display device 200 and the second display device 300, the processor 130 may obtain the pixel shift control information for the first display device 200 and the pixel shift control information for the second display device 300 based on the pixel shift setting information received from the first display device 200 and the pixel shift setting information received from the second display device 300.

According to an embodiment, the processor 130 may transmit the pixel shift control information to the first display device 200 by using the DDC line 620 according to the DDC/CI protocol. The processor 130 may more reliably manage pixel shift operation control by periodically providing such pixel shift control information to the first display device 200 according to the DDC/CI protocol.

The first display device 200 may include the communication interface 210, the display 220, the memory 230, the processor 240, an input interface 250, a video processing unit 260, and an on screen display (OSD) processing unit 270.

The first display device 200 may process and output a video signal received from the electronic device 100.

The communication interface 210 may receive the video signal from the electronic device 100 according to a connected protocol and output the received video signal to the video processing unit 260. The communication interface 210 may include at least one signal input/output port. The communication interface 210 may include, for example, the signal input/output port 211.

The display 220 may display a video according to the video signal received from the video processing unit 260 and an OSD received from the OSD processing unit 270.

The input interface 250 is for receiving an input from a user. The input interface 250 may be at least one of a keypad, a dome switch, a touch panel, a jog wheel, a jog switch, or an infrared key, but embodiments are not limited thereto.

The video processing unit 260 may process the video signal received from the communication interface 210 under the control of the processor 240 and output the processed video signal to the display 220. The video processing unit 260 may process video quality and scaling according to the type of the video signal.

The OSD processing unit 270 may process an execution screen for control of the first display device 200 as an OSD and output the processed execution screen to the display 220.

According to an embodiment, the OSD processing unit 270 may process a graphic user interface for setting a pixel shift operation as an OSD by the control of the processor 240 and output the processed graphic user interface to the display 220. User setting information received through the graphic user interface may be stored in the memory 230 as pixel shift setting information.

The processor 240 according to an embodiment may operate in a first power mode having a high-speed clock signal before entering a power saving mode of the first display device 200 or after releasing the power saving mode. When the first display device 200 enters the power saving mode, the processor 240 may operate by switching to a second power mode having a low-speed clock signal. The second power mode may have a lower power consumption than the first power mode.

According to an embodiment, when the first display device 200 is powered on and the processor 240 operates in the first power mode or is switched from the second power mode to the first power mode, the processor 240 may transmit the pixel shift setting information stored in the memory 230 to the electronic device 100. As described above, the first display device 200 may transmit the pixel shift setting information stored therein to the electronic device 100 whenever the first display device 200 is powered on or awakened from the low power mode.

According to an embodiment, when transmitting the pixel shift setting information stored in the memory 230 to the electronic device 100, the processor 240 may transmit the pixel shift setting information to the electronic device 100 using the DDC line 620 according to the DDC/CI protocol.

According to an embodiment, the processor 240 may receive pixel shift control information from the electronic device 100 in response to transmitting such pixel shift setting information to the electronic device 100.

According to an embodiment, the processor 240 may receive the pixel shift control information from the electronic device 100 by using the DDC line 620 according to the DDC/CI protocol.

According to an embodiment, the processor 240 may receive the pixel shift control information from the electronic device 100 by using the DDC line 620 according to the DDC/CI protocol. The pixel shift control information may include information about a start location of an initial screen, a screen movement direction, a screen movement range, etc. The electronic device 200 may more reliably manage pixel shift operation control by periodically providing such pixel shift control information to the first display device 200 according to the DDC/CI protocol.

According to an embodiment, the processor 240 may extract information used for the pixel shift operation, that is, information about the start location of the initial screen, the screen movement direction, and the screen movement range by decoding the pixel shift control information received according to the DDC/CI protocol. The processor 240 may perform the pixel shift operation according to the extracted information.

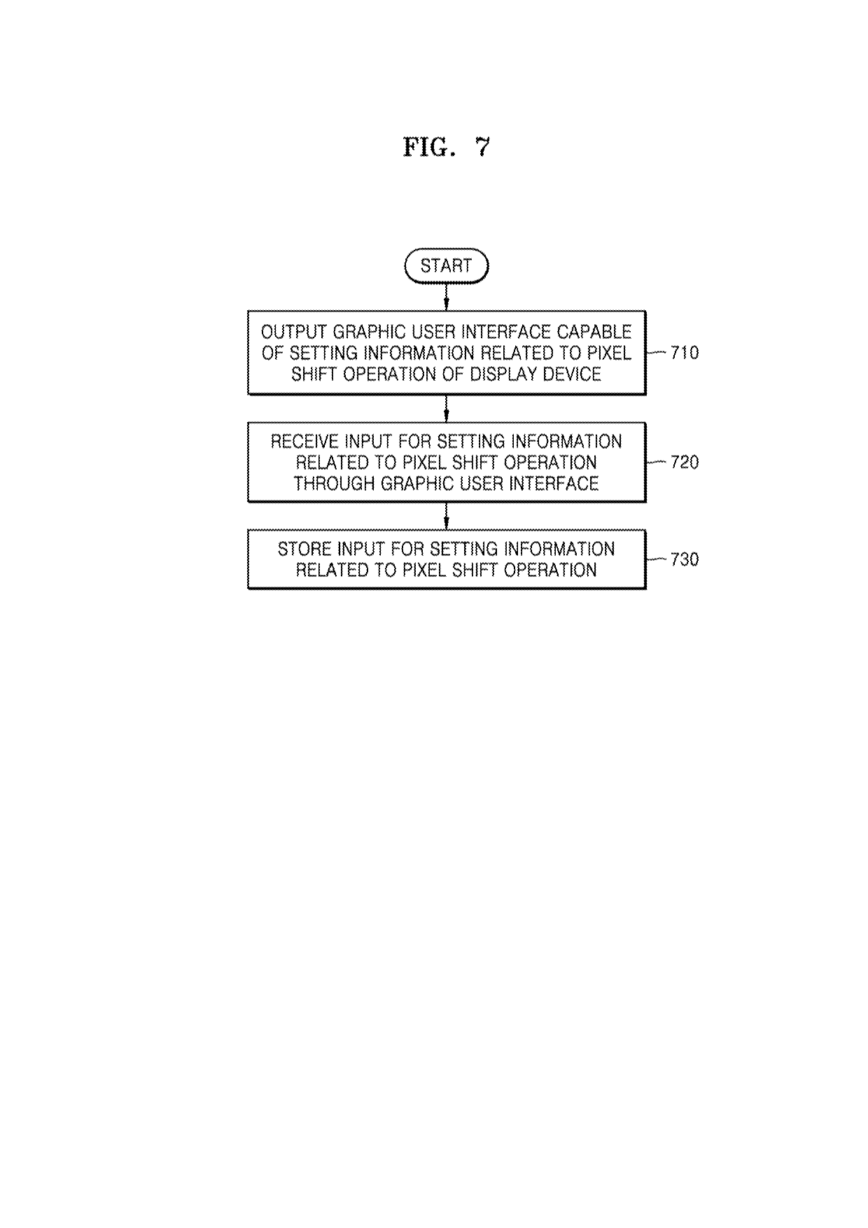

FIG. 7 illustrates an example of a flowchart of a method of operating the first display device 200, according to an embodiment.

Referring to FIG. 7, in operation 710, the first display device 200 may output a graphic user interface capable of setting information related to a pixel shift operation of the first display device 200.

According to an embodiment, the first display device 200 may output the graphic user interface capable of setting the information related to the pixel shift operation by operating an OSD function according to a user input of pressing a button, etc., in front of a display panel. For example, the first display device 200 may receive a user input for activating the OSD function through the input interface 250.

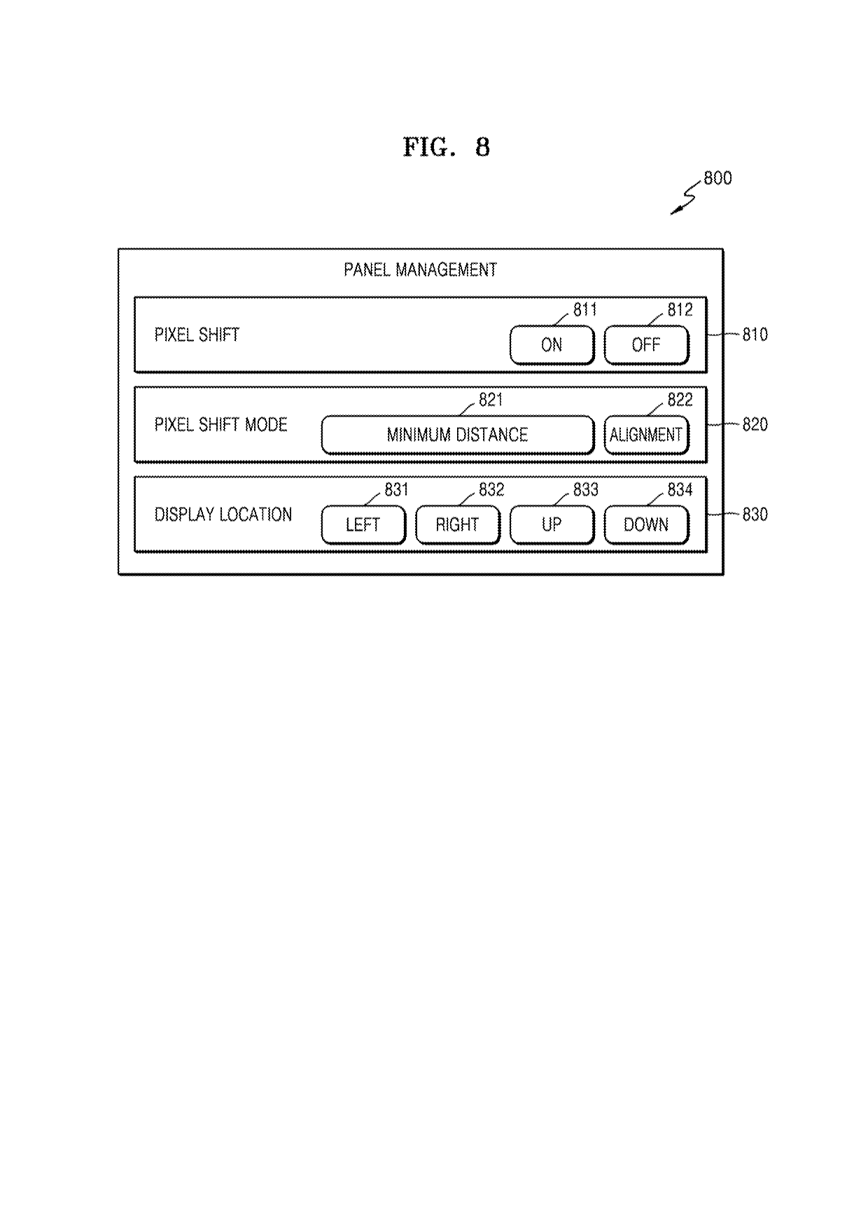

According to an embodiment, the first display device 200 may output the graphic user interface capable of setting the information related to the pixel shift operation by operating the OSD function according to a user input of operating the electronic device 100 connected to the first display device 200. For example, the first display device 200 may receive a command for activating the OSD function from the electronic device 100 through the DDC line 620 shown in FIG. 6. An example of the graphic user interface capable of setting the information related to the pixel shift operation will be described with reference to FIG. 8.

FIG. 8 illustrates an example of a graphic user interface 800 capable of setting information related to a pixel shift operation, according to an embodiment.

Referring to FIG. 8, the graphic user interface 800 capable of setting information related to the pixel shift operation may include a pixel shift on/off setting item 810, a pixel shift mode setting item 820, and a display location setting item 830.

The pixel shift on/off setting item 810 refers to an item capable of setting whether the first display device 200 turns on or off a pixel shift function. When a pixel shift-on 811 is selected, the first display device 200 may be set to activate the pixel shift function, and when a pixel shift-off 812 is selected, the first display device 200 may be set to deactivate the pixel shift function 0.

The pixel shift mode setting item 820 refers to an item for setting a selectable pixel shift mode when the first display device 200 turns on, activates, and operates the pixel shift function. The pixel shift mode may include, for example, a minimum distance mode 821 and an alignment mode 822. The minimum distance mode 821 refers to a mode for setting an initial location of a screen so that display screens of display devices constituting a multi-display system are located closest to each other. The alignment mode 822 refers to a mode for setting the initial location of the screen so that the display screens of display devices constituting the multi-display system are located in the center.

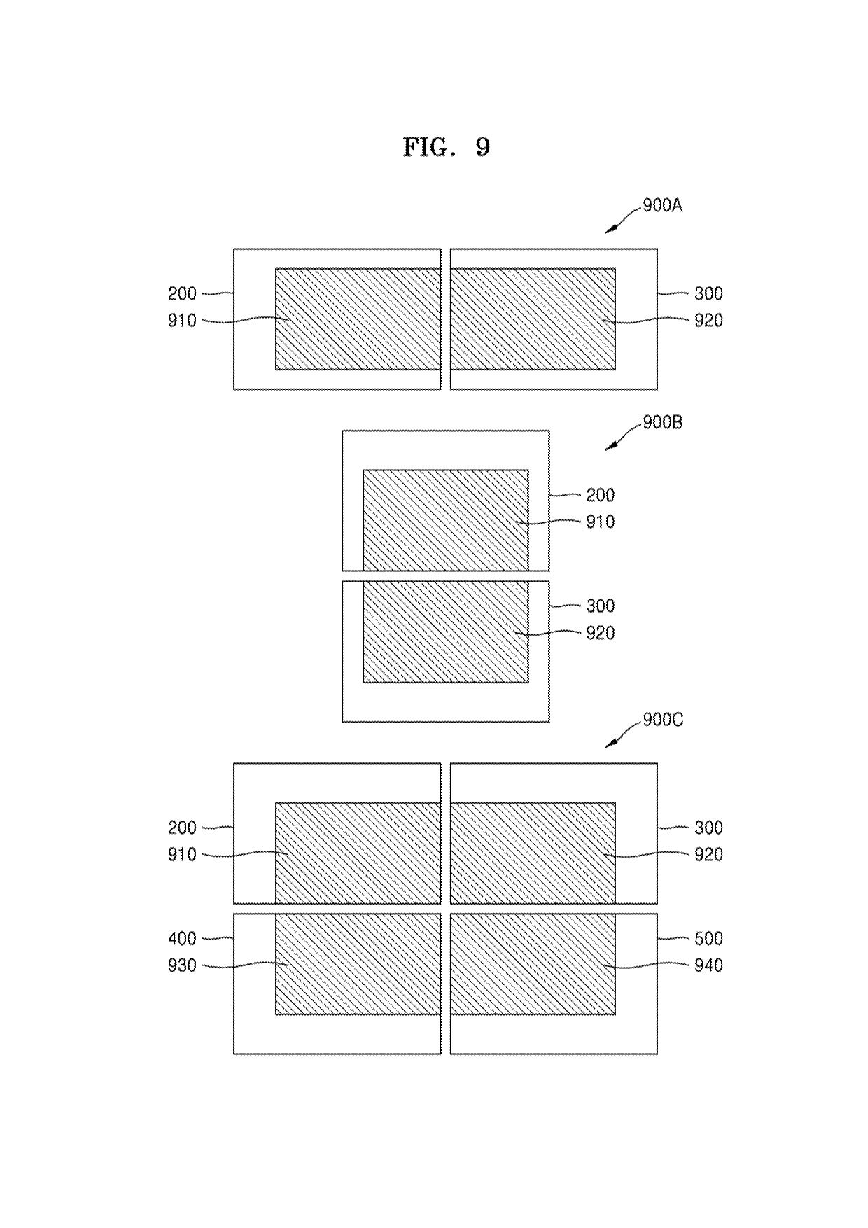

FIG. 9 is a reference diagram for explaining an example of a minimum distance mode according to an embodiment.

Referring to 900A of FIG. 9, when a multi-display system in which the first display device 200 and the second display device 300 are arranged horizontally side by side is configured, the minimum distance mode is that a display start location of a first screen 910 on the left of the multi-display system may be disposed on the right center of a display of the first display device 200 and a display start location of a second screen 920 on the right of the multi-display system may be disposed on the left center of a display of the second display device 300 so that the first screen 910 displaying an image on the first display device 200 and the second screen 920 displaying an image on the second display device 300 have the minimum distance (i.e., so that the distance between the image on the first display device 200 and the image on the second display device 300 is minimized).

Referring to 900B of FIG. 9, when a multi-display system in which the first display device 200 and the second display device 300 are arranged vertically is configured, the minimum distance mode is that a display start location of the first screen 910 located on the upper end of the multi-display system may be disposed on the lower center of the display of the first display device 200, and a display start location of the second screen 920 located on the lower end of the multi-display system may be disposed on the upper center of the display of the second display device 300 so that the first screen 910 displaying an image on the first display device 200 and the second screen 920 displaying an image on the second display device 300 have the minimum distance.

Referring to 900C of FIG. 9, when a multi-display system in which the first display device 200, the second display device 300, a third display device 400, and a fourth display device 500 are in a 2×2 arrangement is configured, the minimum distance mode is that a display start location of the first screen 910 located on the top left of the multi-display system may be disposed on the bottom right of the display of the multi display device 200, a display start location of the second screen 920 located on the top right of the multi-display system may be disposed on the bottom left of the display of the second display device 300, a display start location of the third screen 930 located on the bottom left of the multi-display system may be disposed on the top right of a display of the third display device 400, and a display start location of the fourth screen 940 located on the bottom right of the multi display system may be located on the top left of a display of the fourth display device 500 so that the first screen 910 displaying an image on the first display device 200, the second screen 920 displaying an image on the second display device 300, the third screen 930 displaying an image on the third display device 400, and the fourth screen 940 displaying an image on the fourth display device 500 have the minimum distance.

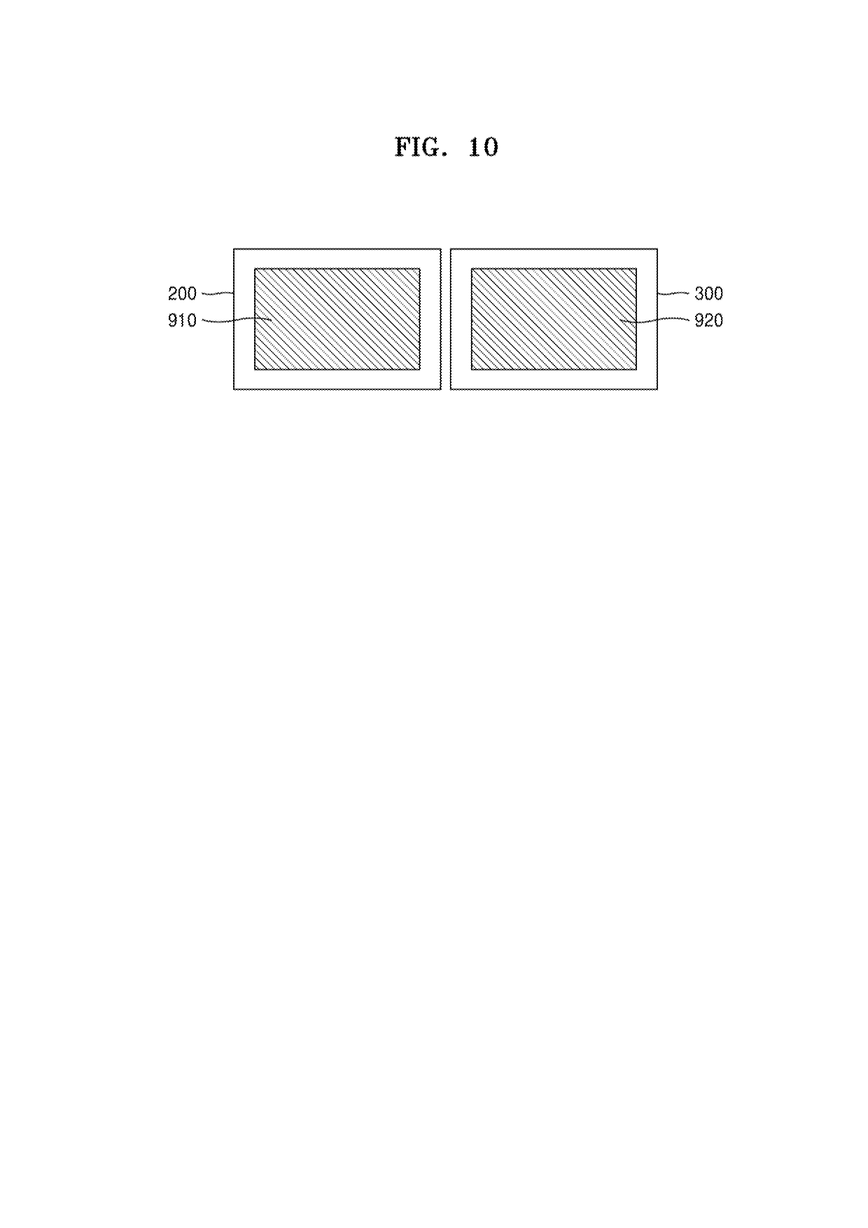

FIG. 10 is a reference diagram for explaining an example of an alignment mode according to an embodiment.

Referring to FIG. 10, when a multi-display system in which the first display device 200 and the second display device 300 are arranged horizontally side by side is configured, the alignment mode is that a display start location of the first screen 910 displaying an image on the first display device 200 may be disposed at the center of a display of the first display device 200, and a display start location of the second screen 920 displaying an image on the second display device 300 may be disposed at the center of a display of the second display device 300.

Referring back to FIG. 8, the display location setting item 830 is an item for setting the location of each display device in the multi-display system. For example, in a system 900A shown in FIG. 9, the first display device 200 may set a display location to left 831, and the second display device 300 may set a display location to right 832. For example, in a system 900B shown in FIG. 9, the first display device 200 may set a display location to up 833, and the second display device 300 may set a display location to down 834. Locations such as the left 831, the right 832, the up 833, and the down 834 are examples, and may be provided to indicate more various locations. For example, in a multi-display system 900C shown in FIG. 9, locations such as left up, left down, right up, and right down may be set to indicate the location of each display device.

Referring back to FIG. 7, in operation 720, the first display device 200 may receive an input for setting information related to the pixel shift operation through the graphic user interface capable of setting the information related to the pixel shift operation.

For example, the first display device 200 may receive a user input for selecting each setting item in the graphic user interface 800 through the input interface 250 provided in the first display device 200 or an input interface of the electronic device 100 connected to the first display device 200.

In operation 730, the first display device 200 may store the input for setting the information related to the pixel shift operation. As described above, the information stored according to the user input may be referred to as pixel shift setting information.

Although the operation of the first display device 200 has been described in FIG. 7, the setting operation may be performed by each display device constituting the multi-display system.

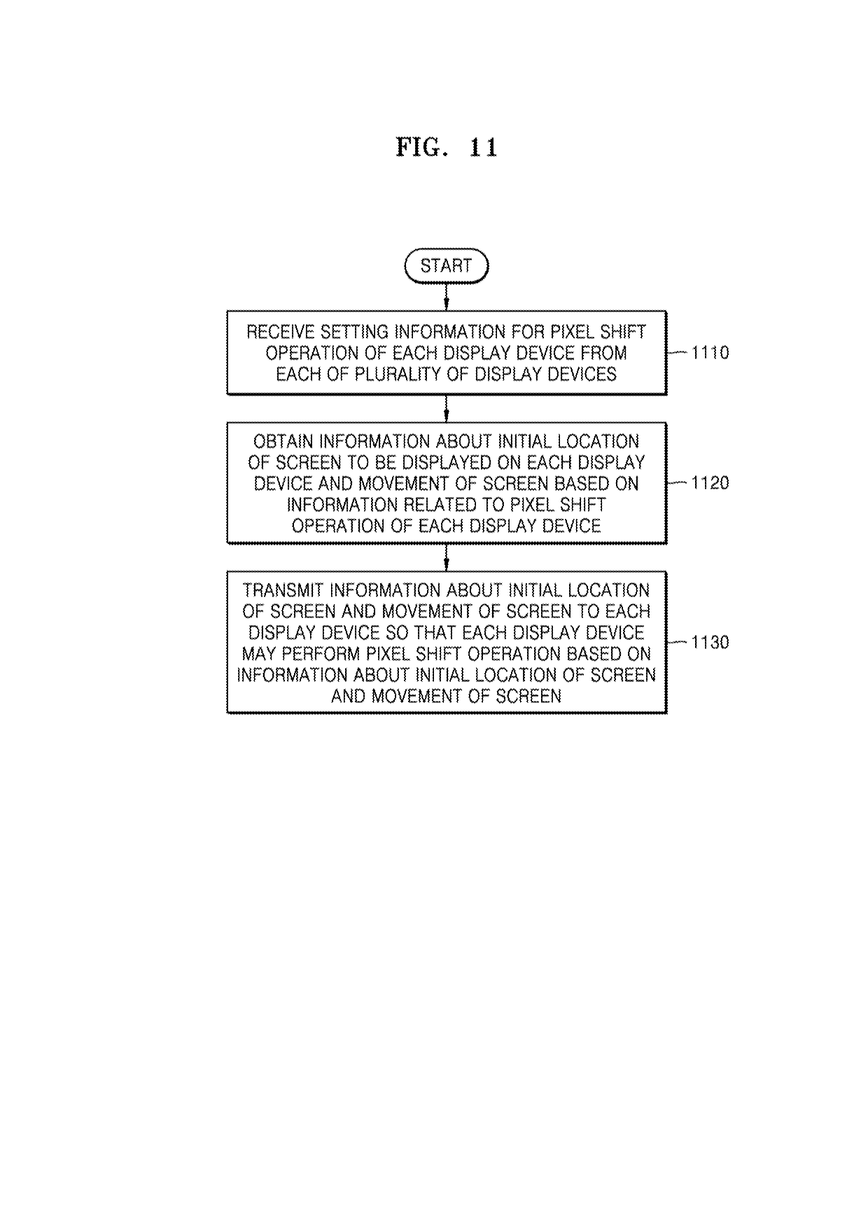

FIG. 11 illustrates an example of a flowchart of a method of operating the electronic device 100, according to an embodiment.

Referring to FIG. 11, in operation 1110, the electronic device 100 may receive setting information for a pixel shift operation of each display device from each of a plurality of display devices.

According to an example, the plurality of display devices may be included in a multi-display system in which two or more display devices are arranged adjacent to each other and used. For example, the multi-display system may include various forms, such as two display devices arranged horizontally side by side, two display devices arranged vertically, or four display devices arranged in a 2x2 form (i.e., two rows and two columns).

According to an embodiment, the electronic device 100 may receive pixel shift setting information of each display device using a wired/wireless communication technology. For example, when the electronic device 100 and the first display device 200 are connected to each other through an HDMI cable, the electronic device 100 may receive the pixel shift setting information from the first display device 200 through the DDC line 620.

The pixel shift setting information received by the electronic device 100 from each display device may include pixel shift mode setting information, display location setting information, and information about dummy pixels. The pixel shift mode setting information and the display location setting information may be information input through a user interface as shown in FIG. 8. The information about dummy pixels is information about dummy pixels arranged by each display device to enable screen movement for the pixel shift operation, and may include information about the number of dummy pixels. The number of dummy pixels may be the same or different depending on the left, right, upper, and lower ends of a display screen.

According to an example, as shown in FIG. 3, the electronic device 100 may receive pixel shift setting information from each of the first display device 200 and the second display device 300.

In operation 1120, the electronic device 100 may obtain pixel shift control information for controlling the pixel shift operation in each display device based on the pixel shift setting information of each display device. The pixel shift control information may include at least one of an initial location of a screen to be displayed on each display device, information about a movement direction of the screen, or information about a movement range of the screen.

According to an embodiment, when the electronic device 100 receives the pixel shift setting information of the first display device 200 and the pixel shift setting information of the second display device 300, the electronic device 100 may obtain the pixel shift control information based on the pixel shift mode setting information, the display location setting information, and the information about dummy pixels included in the pixel shift setting information.

For example, when the pixel shift mode setting information indicates the minimum distance mode, the display location of the first display device 200 indicates the left, and the display location of the second display device 300 indicates the right based on the pixel shift setting information received from each of the first display device 200 and the second display device 300, the electronic device 100 may set the location of an initial start screen of the first display device 200 to the right center, and the location of an initial start screen of the second display device 300 to the left center. In addition, the electronic device 100 may determine the pixel shift movement direction and the pixel shift movement range based on the received information about dummy pixels. For example, the electronic device 100 may determine the pixel shift movement direction according to a predetermined algorithm. For example, when the location of the initial start screen is the left center and the right center, the electronic device 100 may determine the pixel shift movement direction upward and downward so as to perform the pixel shift operation while maintaining the minimum distance between the two screens. That is, in this case, the electronic device 100 may determine that the two screens move only up and down without moving left and right. For example, the electronic device 100 may determine the pixel shift movement range according to a predetermined algorithm. For example, when the number of dummy pixels is 10, the electronic device 100 may determine the pixel shift movement range as 10.

For example, when the pixel shift mode setting information indicates the minimum distance mode, the display location of the first display device 200 indicates the upper end, and the display location of the second display device 300 indicates the lower end based on the pixel shift setting information received from each of the first display device 200 and the second display device 300, the electronic device 100 may set the location of the initial start screen of the first display device 200 to the lower center, and the location of the initial start screen of the second display device 300 to the upper center. In addition, the electronic device 100 may determine the pixel shift movement direction and the pixel shift movement range based on the received information about dummy pixels. For example, the electronic device 100 may determine the pixel shift movement direction according to a predetermined algorithm. For example, when the location of the initial start screen is the lower center and the upper center, the electronic device 100 may determine the pixel shift movement direction to the left and right directions so as to perform the pixel shift operation while maintaining the minimum distance between the two screens. That is, in this case, the electronic device 100 may determine that the two screens move only left and right without moving up and down. For example, the electronic device 100 may determine the pixel shift movement range according to a predetermined algorithm. For example, when the number of dummy pixels is 10, the electronic device 100 may determine the pixel shift movement range as 10.

In operation 1130, the electronic device 100 may transmit the pixel shift control information to each display device so that each display device may perform the pixel shift operation based on the initial location of the screen and information about the movement of the screen.

According to an embodiment, the electronic device 100 may transmit the pixel shift control information to each display device using a wired/wireless communication technology. For example, when the electronic device 100 and the first display device 200 are connected to each other through an HDMI cable, the electronic device 100 may transmit the pixel shift control information to the first display device 200 through the DDC line 620.

Each display device receiving the pixel shift control information as described above may perform the pixel shift operation according to the pixel shift control information.

As described above, the multi-display system including a plurality of display devices organically determines the pixel shift control information of each display device based on the pixel shift setting information of each display device, such that the plurality of display devices may organically perform the pixel shift operation on display screens.

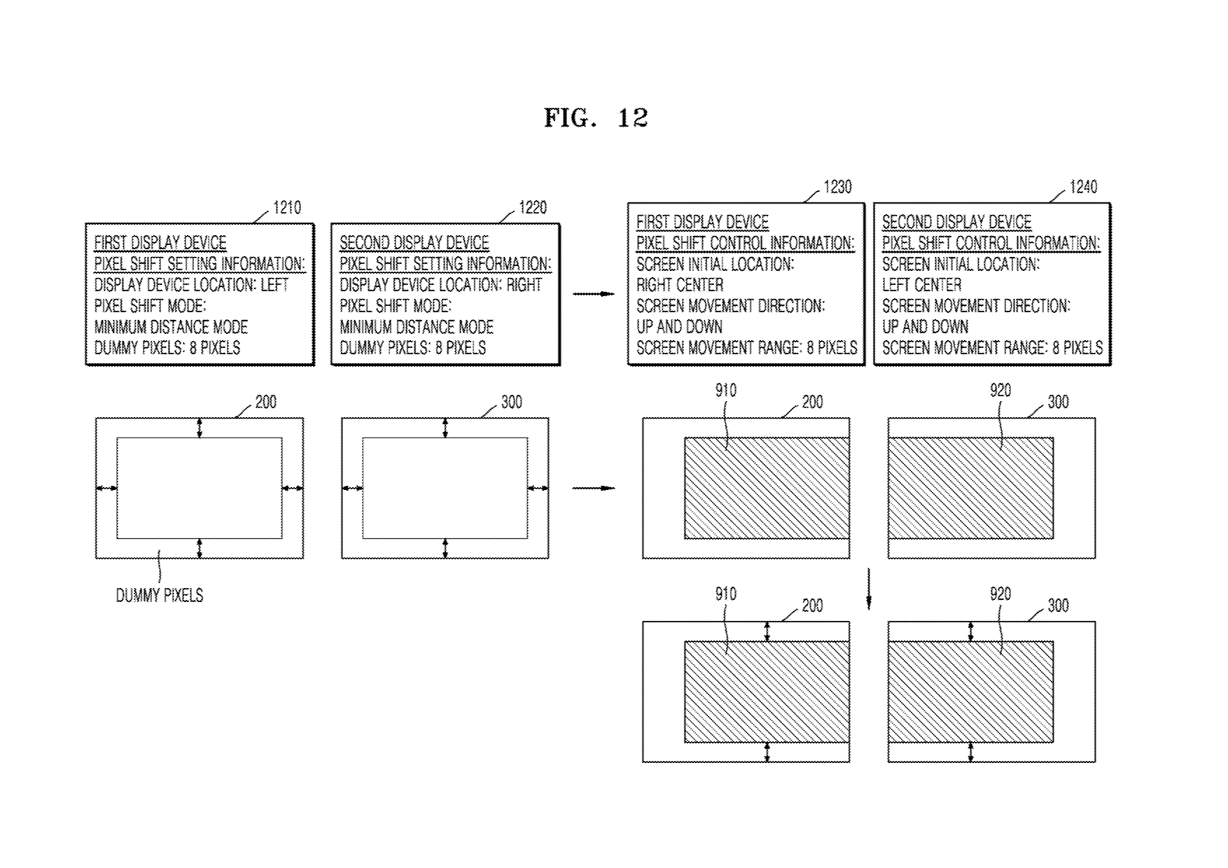

FIG. 12 is a reference diagram for explaining a pixel shift operation when two display devices are arranged horizontally side by side, according to an embodiment.

Referring to FIG. 12, the first display device 200 may provide its own pixel shift setting information 1210 to the electronic device 100. In the pixel shift setting information 1210 of the first display device 200, a display device location may indicate the left, a pixel shift mode may indicate the minimum distance mode, and dummy pixels may indicate 8 pixels. The second display device 300 may provide its pixel shift setting information 1220 to the electronic device 100. In the pixel shift setting information 1220 of the second display device 300, a display device location may indicate the right, a pixel shift mode may indicate the minimum distance mode, and dummy pixels may indicate 8 pixels.

The electronic device 100 that has received the pixel shift setting information 1210 of the first display device 200 and the pixel shift setting information 1220 of the second display device 300 may determine pixel shift control information based on the pixel shift setting information 1210 and the pixel shift setting information 1220. Because the pixel shift mode of each of the first display device 200 and the second display device 300 indicates the minimum distance mode, the electronic device 100 may determine the pixel shift control information so that locations of initial screens of the first display device 200 and the second display device 300 are minimally separated. For example, the electronic device 100 may obtain pixel shift control information 1230 of the first display device 200 in which an initial screen location indicates the right center, a screen movement direction indicates up and down, and a screen movement range indicates 8 pixels. For example, the electronic device 100 may obtain pixel shift control information 1240 of the second display device 300 in which an initial screen location indicates the left center, a screen movement direction indicates up and down, and a screen movement range indicates 8 pixels.

When the electronic device 100 transmits the obtained pixel shift control information 1230 of the first display device 200 to the first display device 200 and transmits the pixel shift control information 1240 of the second display device 300 to the second display device 300, the first display device 200 and the second display device 300 may perform pixel shift operations based on the received pixel shift control information 1230 and 1240, respectively.

That is, the first display device 200 may set the location of the initial screen to the right center of a display, and the second display device 300 may set the location of the initial screen to the left center of a display. In addition, the first display device 200 and the second display device 300 may perform pixel shift operations while maintaining the minimum distance between the screen of the first display device 200 and the screen of the second display device 300 by moving the screen movement direction up and down and setting the movement range to 8 pixels according to the pixel shift control information 1230 and 1240, respectively.

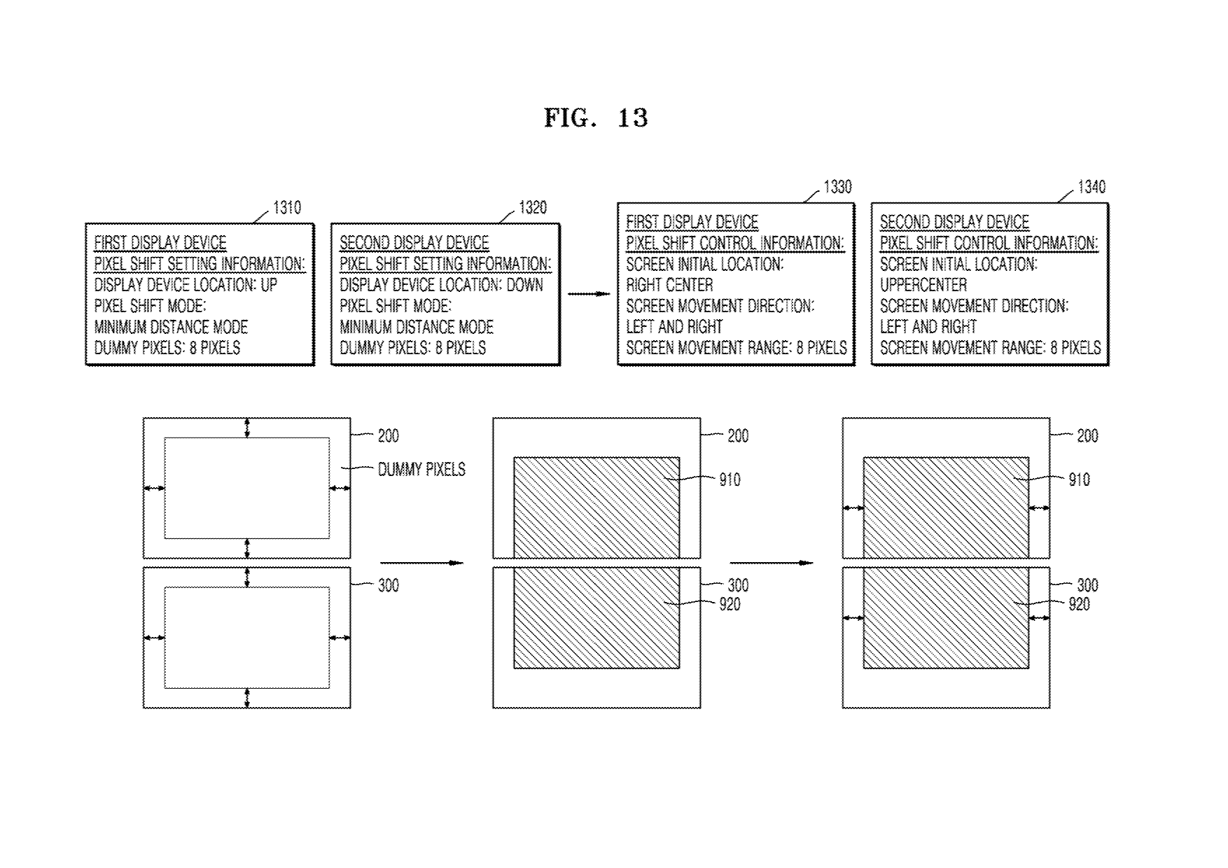

FIG. 13 is a reference diagram for explaining a pixel shift operation when two display devices are vertically arranged, according to an embodiment.

Referring to FIG. 13, the first display device 200 may provide its own pixel shift setting information 1310 to the electronic device 100. In the pixel shift setting information 1310 of the first display device 200, a display device location may indicate the upper end, a pixel shift mode may indicate the minimum distance mode, and dummy pixels may indicate 8 pixels. The second display device 300 may provide its pixel shift setting information 1320 to the electronic device 100. In the pixel shift setting information 1320 of the second display device 300, a display device location may indicate the lower end, a pixel shift mode may indicate the minimum distance mode, and dummy pixels may indicate 8 pixels.

The electronic device 100 that has received the pixel shift setting information 1310 of the first display device 200 and the pixel shift setting information 1320 of the second display device 300 may determine pixel shift control information based on the pixel shift setting information 1310 and the pixel shift setting information 1320. Because the pixel shift mode of each of the first display device 200 and the second display device 300 indicates the minimum distance mode, the electronic device 100 may determine the pixel shift control information so that locations of initial screens of the first display device 200 and the second display device 300 are minimally separated. For example, the electronic device 100 may obtain pixel shift control information 1330 of the first display device 200 in which an initial screen location indicates the lower center, a screen movement direction indicates left and right, and a screen movement range indicates 8 pixels. For example, the electronic device 100 may obtain pixel shift control information 1340 of the second display device 300 in which an initial screen location indicates the upper center, a screen movement direction indicates left and right, and a screen movement range indicates 8 pixels.

When the electronic device 100 transmits the obtained pixel shift control information 1330 of the first display device 200 to the first display device 200 and transmits the pixel shift control information 1340 of the second display device 300 to the second display device 300, the first display device 200 and the second display device 300 may perform pixel shift operations based on the received pixel shift control information 1330 and 1340, respectively.

That is, the first display device 200 may set the location of the initial screen to the lower center of a display, and the second display device 300 may set the location of the initial screen to the upper center of a display. In addition, the first display device 200 and the second display device 300 may perform pixel shift operations while maintaining the minimum distance between the screen of the first display device 200 and the screen of the second display device 300 by moving the screen movement direction left and right and setting the movement range to 8 pixels according to the pixel shift control information 1330 and 1340, respectively.

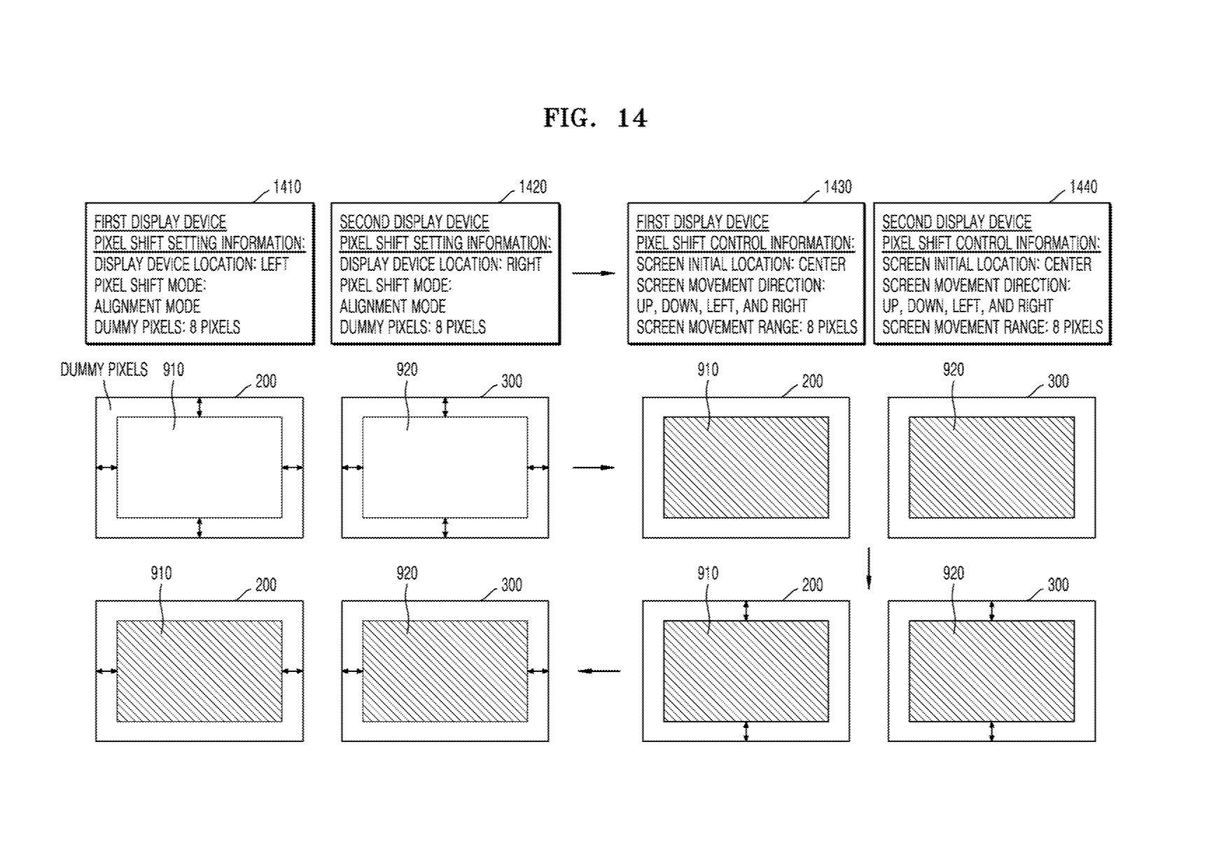

FIG. 14 is a reference diagram for explaining a pixel shift operation when two display devices are arranged horizontally side by side, according to an embodiment.

Referring to FIG. 14, the first display device 200 may provide its own pixel shift setting information 1410 to the electronic device 100. In the pixel shift setting information 1410 of the first display device 200, a display device location may indicate the left, a pixel shift mode may indicate an alignment mode, and dummy pixels may indicate 8 pixels. The second display device 300 may provide its pixel shift setting information 1420 to the electronic device 100. In the pixel shift setting information 1420 of the second display device 300, a display device location may indicate the right, a pixel shift mode may indicate the minimum distance mode, and dummy pixels may indicate 8 pixels.

The electronic device 100 that has received the pixel shift setting information 1410 of the first display device 200 and the pixel shift setting information 1420 of the second display device 300 may determine pixel shift control information based on the pixel shift setting information 1410 and the pixel shift setting information 1420. Because the pixel shift mode of each of the first display device 200 and the second display device 300 indicates the alignment mode, the electronic device 100 may determine the pixel shift control information so that initial screens of the first display device 200 and the second display device 300 are aligned at the same location. For example, the electronic device 100 may obtain pixel shift control information 1430 of the first display device 200 in which an initial screen location indicates the center, a screen movement direction indicates up, down, left, and right, and a screen movement range indicates 8 pixels. For example, the electronic device 100 may obtain pixel shift control information 1440 of the second display device 300 in which an initial screen location indicates the center, a screen movement direction indicates up, down, left, and right, and a screen movement range indicates 8 pixels.

When the electronic device 100 transmits the obtained pixel shift control information 1430 of the first display device 200 to the first display device 200 and transmits the pixel shift control information 1440 of the second display device 300 to the second display device 300, the first display device 200 and the second display device 300 may perform pixel shift operations based on the received pixel shift control information 1430 and 1440, respectively.

That is, the first display device 200 may set the location of the initial screen to the center of a display, and the second display device 300 may set the location of the initial screen to the center of a display. In addition, the first display device 200 and the second display device 300 may perform pixel shift operations while the screen of the first display device 200 and the screen of the second display device 300 are in the same location on each display device by moving the screen movement direction up, down, left, and right and setting the movement range to 8 pixels according to the pixel shift control information 1430 and 1440, respectively.

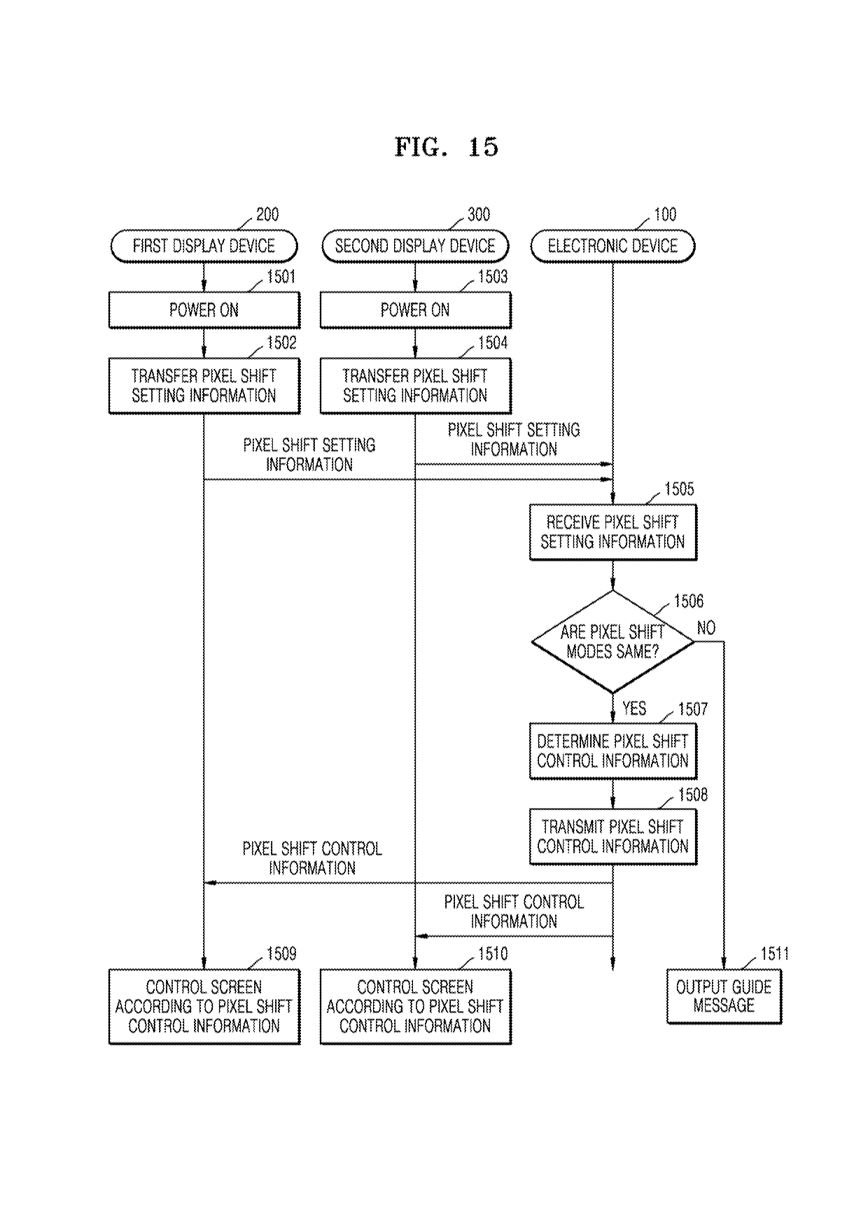

FIG. 15 illustrates an example of a flowchart of a method of operating the electronic device 100 according to an embodiment.

Referring to FIG. 15, in operation 1501, the first display device 200 may be powered on or switched from a low power mode to a normal mode.

In operation 1502, when the first display device 200 is powered on or awakened from the low power mode as described above, the first display device 200 may transmit its pixel shift setting information to the electronic device 100. In this regard when the first display device 200 is connected to the electronic device 100 through an HDMI cable, the first display device 200 may transmit its pixel shift setting information to the electronic device 100 through a display data channel/command interface (DDC/CI).

In operation 1503, the second display device 300 may be powered on or switched from the low power mode to the normal mode.

In operation 1504, when the second display device 300 is powered on or awakened from the low power mode, the second display device 300 may transmit its pixel shift setting information to the electronic device 100. In this regard, when the second display device 300 is connected to the electronic device 100 through an HDMI cable, the second display device 300 may transmit its pixel shift setting information to the electronic device 100 through the DDC/CI.

In operation 1505, the electronic device 100 may receive the pixel shift setting information of the first display device 200 and the pixel shift setting information of the second display device 300.

In operation 1506, the electronic device 100 may determine whether a pixel shift mode of the first display device 200 is the same as a pixel shift mode of the second display device 300. When the pixel shift mode of the first display device 200 is the same as the pixel shift mode of the second display device 300, operation 1507 may be performed.

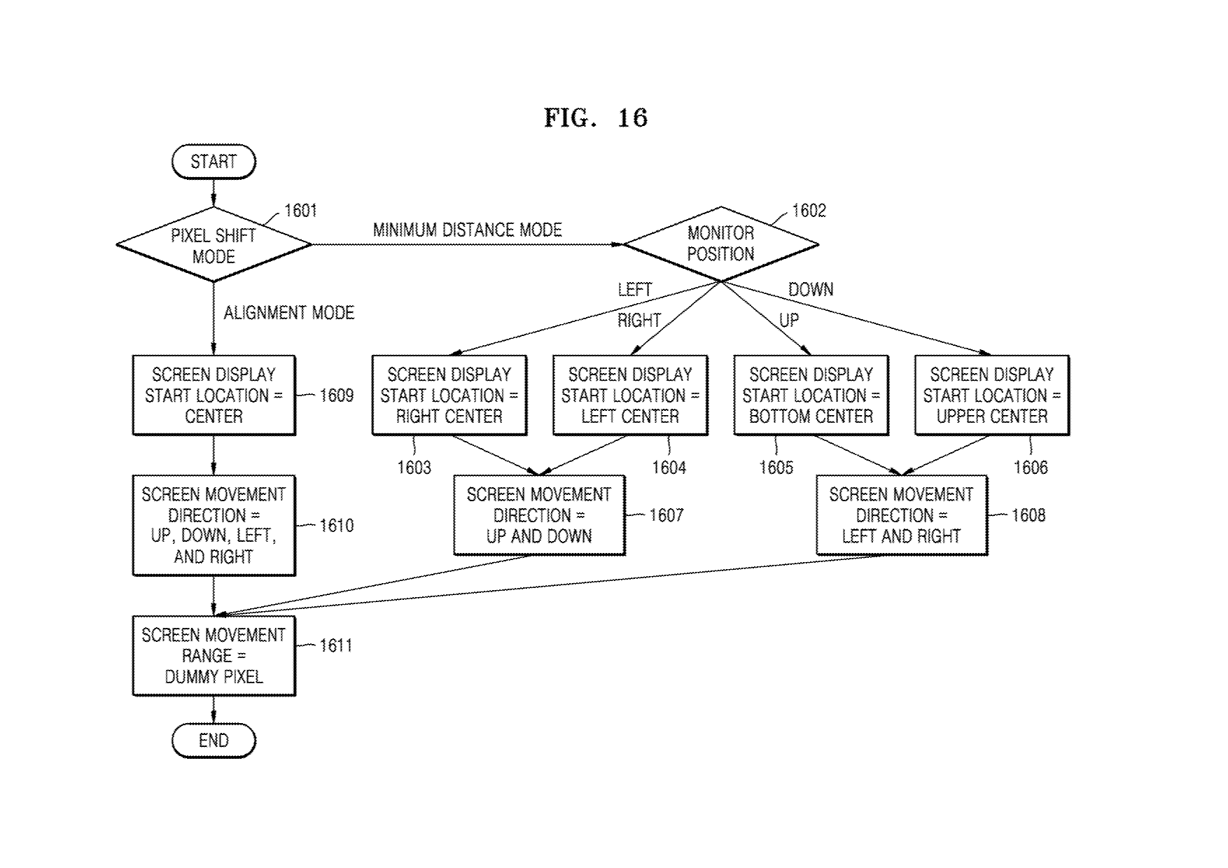

In operation 1507, the electronic device 100 may determine pixel shift control information. A method, performed by the electronic device 100, of determining the pixel shift control information will be described in detail with reference to FIG. 16.

FIG. 16 illustrates an example of a method, performed by the electronic device 100, of obtaining pixel shift control information, according to an embodiment.

Referring to FIG. 16, in operation 1601, the electronic device 100 may determine whether a pixel shift mode is a minimum distance mode or an alignment mode.

When the pixel shift mode is the minimum distance mode, operation 1602 may be performed.

In operation 1602, the electronic device 100 may determine the location of a display device.

In operation 1603, when the location of the display device is on the left, the electronic device 100 may determine a screen display start location as the right center.

In operation 1604, when the location of the display device is on the right, the electronic device 100 may determine the screen display start location as the left center.

In operation 1605, when the location of the display device is on the upper end, the electronic device 100 may determine the screen display start location as the lower center.

In operation 1606, when the location of the display device is on the lower end, the electronic device 100 may determine the screen display start location as the upper center.

In operation 1607, when the screen display start location is determined to be the right center and the left center, the electronic device 100 may determine a screen movement direction as up and down.

In operation 1608, when the screen display start location is determined as the upper center and the lower center, the electronic device 100 may determine the screen movement direction as left and right.

As a result of determining in operation 1601, when the pixel shift mode is the alignment mode, operation 1609 may be performed.

In operation 1609, the electronic device 100 may determine screen display start locations of display devices as the center.

In operation 1610, the electronic device 100 may determine the screen movement direction as up, down, left, and right.

In operation 1611, the electronic device 100 may determine a screen movement range based on the number of dummy pixels. Based on such a method, the electronic device 100 may obtain the pixel shift control information including a screen display start location, a screen movement direction, and a screen movement range of each of the first display device 200 and the second display device 300.

Referring back to FIG. 15, in operation 1508, the electronic device 100 may transmit the pixel shift control information to each display device. That is, the electronic device 100 may transmit the determined pixel shift control information of the first display device 200 to the first display device 200 and transmit the determined pixel shift control information of the second display device 300 to the second display device 300.

In this regard, the electronic device 100 may transmit the pixel shift control information using the DDC/CI.

In operation 1509, the first display device 200 may control screen movement according to the pixel shift control information received from the electronic device 100. That is, the first display device 200 may place an initial screen at the screen display start location indicated by the pixel shift control information, move the screen according to the screen movement direction indicated by the pixel shift control information, and move the screen by the screen movement range indicated by the pixel shift control information.

In operation 1510, the second display device 300 may control screen movement according to the pixel shift control information received from the electronic device 100. That is, the second display device 300 may place the initial screen at the screen display start location indicated by the pixel shift control information, move the screen according to the screen movement direction indicated by the pixel shift control information, and move the screen by the screen movement range indicated by the pixel shift control information.

In operation 1506, when it is determined that the pixel shift mode of the first display device 200 is not the same as the pixel shift mode of the second display device 300, operation 1511 may be performed.

When the pixel shift mode set in the first display device 200 and the pixel shift mode set in the second display device 300 are not the same, it may be difficult for the electronic device 100 to determine which mode to proceed. Therefore, in this case, the electronic device 100 may output a guide message to confirm the user’s intention.

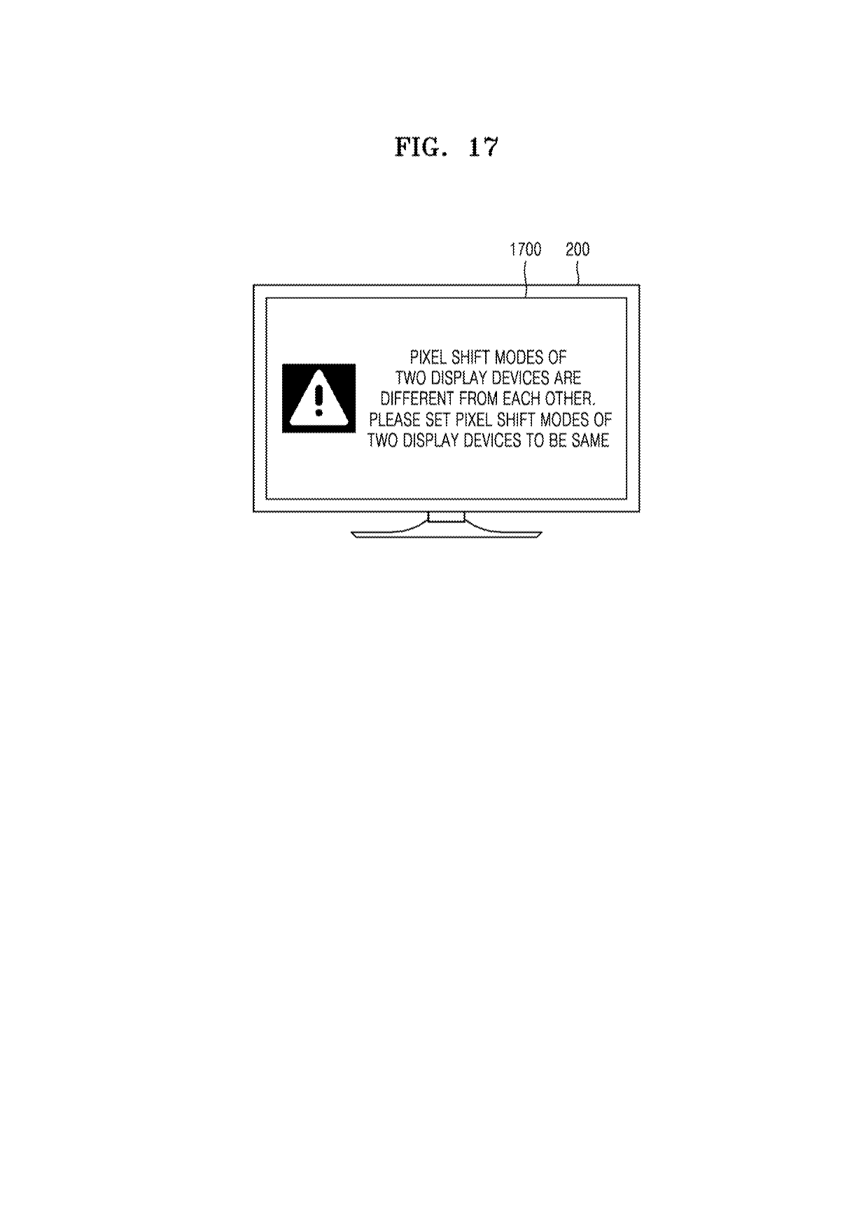

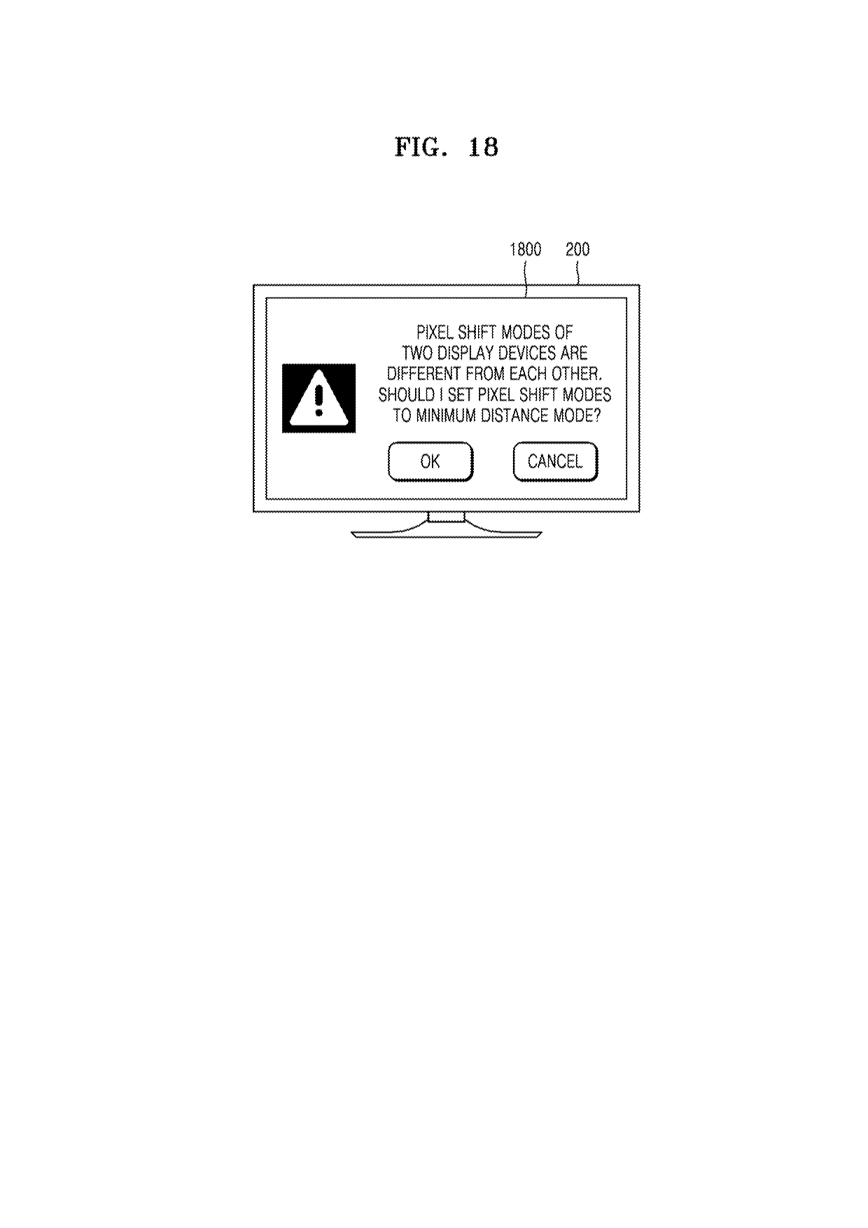

In operation 1511, the electronic device 100 may output the guide message 1700. For example, as shown in FIG. 17, the electronic device 100 may output a guide message 1700 <Pixel shift modes of two display devices are different from each other. Please set the pixel shift modes of the two display devices to be the same.> to guide the user to set the pixel shift modes of the display devices to be the same. Alternatively, for example, as shown in FIG. 18, the electronic device 100 may output a guide message 1800 <Pixel shift modes of two display devices are different from each other. Should I set the pixel shift modes to the minimum distance mode?> to guide the user to select the minimum distance mode immediately.

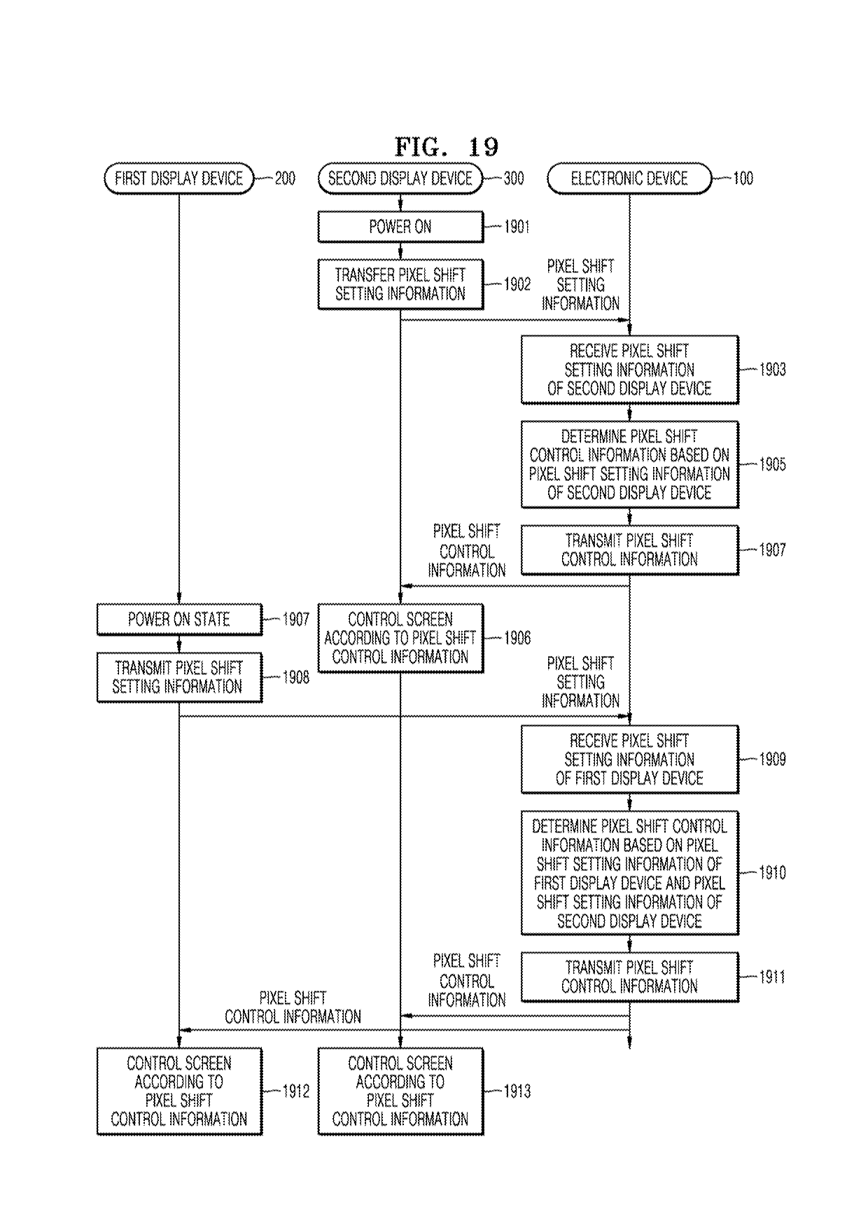

FIG. 19 illustrates an example of a flowchart of a method of operating the electronic device 100 according to an embodiment.

Referring to FIG. 19, in operation 1901, the second display device 300 may be powered on or switched from a low power mode to a normal mode.

In operation 1902, when the second display device 300 is powered on or awakened from the low power mode, the second display device 300 may transmit its pixel shift setting information to the electronic device 100. In this regard, when the second display device 300 is connected to the electronic device 100 through an HDMI cable, the second display device 300 may transmit its pixel shift setting information to the electronic device 100 through the DDC/CI.

In operation 1903, the electronic device 100 may receive the pixel shift setting information of the second display device 300.

In operation 1904, the electronic device 100 may determine pixel shift control information of the second display device 300 based on the pixel shift setting information of the second display device 300. In this case, because the electronic device 100 has received pixel shift setting information from only one display device, the electronic device 100 needs to determine the pixel shift control information based on only the pixel shift setting information of the second display device 300.

Because information about a pixel shift mode included in the pixel shift setting information relates to how to deal with a screen when two or more display devices are present, when the electronic device 100 has received pixel shift setting information from one display device, the electronic device 100 may determine a screen start location as the center without having to consider the pixel shift mode. When the electronic device 100 has received pixel shift setting information from one display device, the electronic device 100 may determine a screen movement direction without limitation. For example, the electronic device 100 may determine the screen movement direction as up, down, left, and right. The electronic device 100 may determine a screen movement range based on information about dummy pixels included in the pixel shift setting information of the second display device 300.

In operation 1905, the electronic device 100 may transmit the determined pixel shift control information of the second display device 300 to the second display device 300.

In operation 1906, the second display device 300 may control the screen movement based on the received pixel shift control information.

As described above, the second display device 300 may be powered on first to display the screen, and then, in operation 1907, the first display device 200 may be powered on or switched from the low power mode to the normal mode.

In operation 1908, when the first display device 200 is powered on or awakened from the low power mode, the first display device 200 may transmit its pixel shift setting information to the electronic device 100. In this regard, when the first display device 200 is connected to the electronic device 100 through an HDMI cable, the first display device 200 may transmit its pixel shift setting information to the electronic device 100 through the DDC/CI.

In operation 1909, the electronic device 100 may receive the pixel shift setting information of the first display device 200.

In operation 1910, the electronic device 100 may determine pixel shift control information based on the pixel shift setting information of the first display device 200 and the pixel shift setting information of the second display device 300. A method of determining the pixel shift control information is the same as that described with reference to FIG. 16, and thus further description thereof will be omitted.

In operation 1911, the electronic device 100 may respectively transmit the pixel shift control information of the first display device 200 and the pixel shift control information of the second display device 300 to the first display device 200 and the second display device 300.

In this regard, the electronic device 100 may transmit the pixel shift control information through the DDC/CI.

In operation 1912, the first display device 200 may control screen movement according to the pixel shift control information received from the electronic device 100. That is, the first display device 200 may place an initial screen at the screen display start location indicated by the pixel shift control information, move the screen according to the screen movement direction indicated by the pixel shift control information, and move the screen by the screen movement range indicated by the pixel shift control information.

In operation 1913, the second display device 300 may control the screen movement according to the pixel shift control information received from the electronic device 100. That is, the second display device 300 may place the initial screen at the screen display start location indicated by the pixel shift control information, move the screen according to the screen movement direction indicated by the pixel shift control information, and move the screen by the screen movement range indicated by the pixel shift control information.

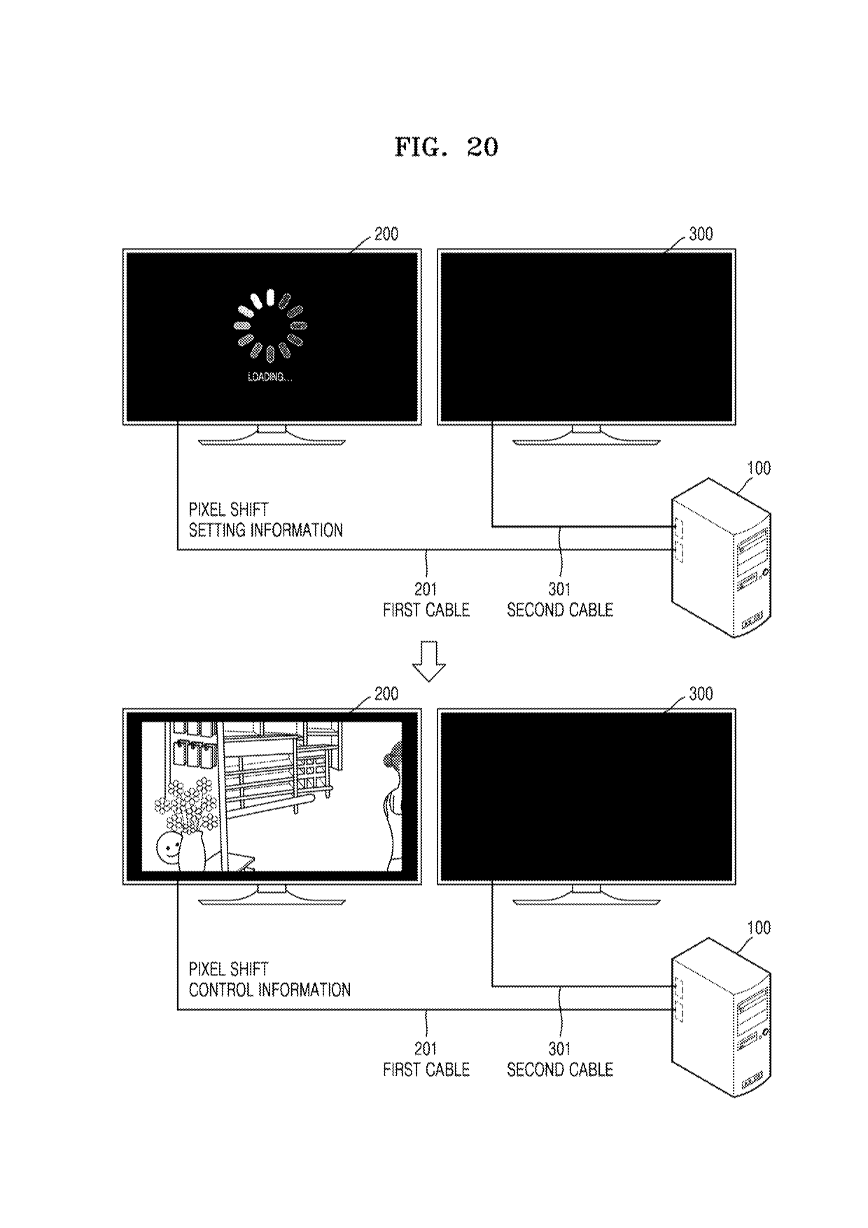

FIG. 20 is a reference diagram for explaining a pixel shift operation when one display device is powered on, according to an embodiment.

Referring to FIG. 20, both the first display device 200 and the second display device 300 are connected to the electronic device 100. When both the first display device 200 and the second display device 300 are in a power off state and then only the first display device 200 is powered on, the first display device 200 may transmit the stored pixel shift setting information to the electronic device 100.

Then, the electronic device 100 may obtain pixel shift control information based on the pixel shift setting information of the first display device 200 and transmit the pixel shift control information to the first display device 200. Then, the first display device 200 may perform the pixel shift operation based on the pixel shift control information received from the electronic device 100. The first display device 200 may output a video display start screen to the center of a display based on the pixel shift control information received from the electronic device 100 and move the screen to up, down, left, and right to perform the pixel shift operation.

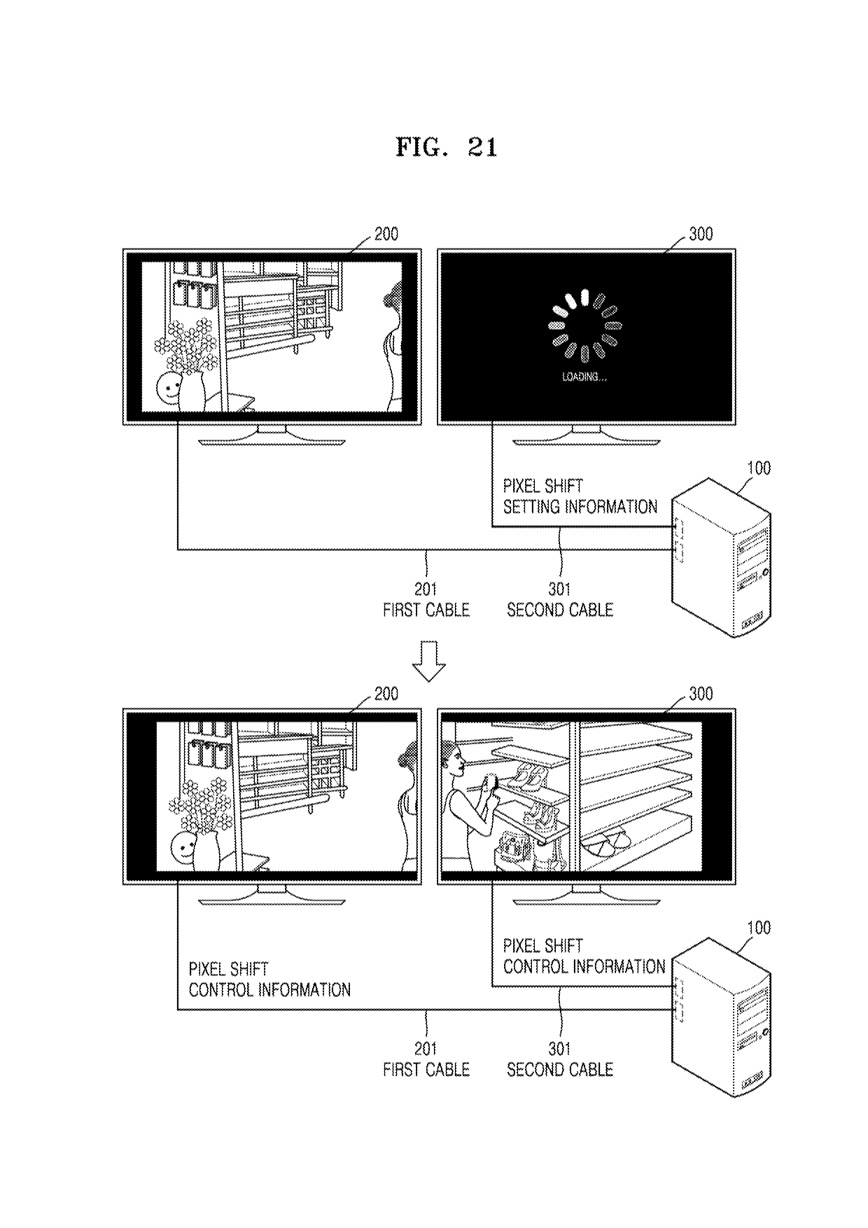

FIG. 21 is a reference diagram for explaining a pixel shift operation when one display device is powered on, according to an embodiment.

While both the first display device 200 and the second display device 300 are connected to the electronic device 100 as shown in FIG. 20, when only the first display device 200 is powered on, and the second display device 300 is also powered on while the first display 200 performs the pixel shift operation as shown in FIG. 19, the second display device 300 may transmit stored pixel shift setting information to the electronic device 100.

Then, because the electronic device 100 has received pixel shift setting information of both the first display device 200 and the second display device 300, the electronic device 100 may obtain pixel shift control information based on the pixel shift setting information of the first display device 200 and the pixel shift setting information of the second display device 300. The electronic device 100 may transmit the pixel shift control information to each of the first display device 200 and the second display device 300. Then, the first display device 200 and the second display device 300 may perform the pixel shift operations based on the pixel shift control information received from the electronic device 100. When the first display device 200 is powered on alone (i.e., while the second display device 300 is powered off), the first display device 200 may receive the pixel shift control information and perform the pixel shift operation accordingly, and then when the second display device 300 is also powered on, the first display device 200 may receive updated pixel shift control information from the electronic device 100 so as to organically perform the pixel shift operations of the first display device 200 and the second display device 300. For example, when the first display device 200 is powered on alone, a video display screen is disposed in the center, and when the second display device 300 is powered on a video display screen of the first display device 200 may be changed to the right center to maintain the minimum distance between screens of the first display device 200 and the second display device 300.

According to an embodiment, an electronic device may include a communication interface, a memory storing one or more instructions, and at least one processor configured to execute the one or more instructions stored in the memory. The one or more instructions, when executed by the at least one processor individually and/or collectively, may cause the electronic device to control the communication interface to receive information related to a pixel shift operation of each of a plurality of display devices from each of the plurality of display devices. The one or more instructions, when executed by the at least one processor individually and/or collectively, may cause the electronic device to obtain information about an initial location of a screen and a movement of the screen to be displayed on each of the plurality of display devices, based on the information related to the pixel shift operation of each of the plurality of display devices. The one or more instructions, when executed by the at least one processor individually and/or collectively, may cause the electronic device to control the communication interface to transmit the information about the initial location of the screen and the movement of the screen to each of the plurality of display devices so that each of the plurality of display devices may perform the pixel shift operation based on the information about the initial location of the screen and the movement of the screen.

The information related to the pixel shift operation of each of the plurality of display devices may include information about a pixel shift mode indicating one of a minimum distance mode for minimizing a distance between screen display locations of the plurality of display devices and an alignment mode for setting screens to be displayed at a same location on the plurality of display devices, and information about a location of each of the plurality of display devices in a display system configured based on the plurality of display devices.

The one or more instructions, when executed by the at least one processor individually and/or collectively, may cause the electronic device to determine initial locations of screens in the plurality of display devices so that the distance between the screens displayed on the plurality of display devices is minimized, based on the pixel shift mode indicating the minimum distance mode.

The one or more instructions, when executed by the at least one processor individually and/or collectively, may cause the electronic device to determine the initial location of the screen so that the screen is disposed at a right end in a display device located on the left, and determine the initial location of the screen so that the screen is disposed at a left end in a display device located on the right when the locations of the plurality of display devices are indicated as the left and the right.

The one or more instructions, when executed by the at least one processor individually and/or collectively, may cause the electronic device to determine the initial location of the screen so that the screen is disposed at a lower end in a display device disposed on an upper end, and determine the initial location of the screen so that the screen is disposed at a top end in a display device disposed on the lower end when the locations of the plurality of display devices are indicated as the upper and the lower ends.

The one or more instructions, when executed by the at least one processor individually and/or collectively, may cause the electronic device to determine the initial location of the screen in each of the plurality of display devices so that the screens are displayed at a same location on the plurality of display devices, based on the pixel shift mode indicating the alignment mode.

The one or more instructions, when executed by the at least one processor individually and/or collectively, may cause the electronic device to output a message guiding to set pixel shift modes of the plurality of display devices to be same when the pixel shift modes of the plurality of display devices indicate different modes.

The information about the movement of the screen may include information about a movement direction of the screen and information about a movement range of the screen.

The communication interface may include a high definition multimedia interface (HDMI) display data channel (DDC)/ command interface (CI) communication channel.

The electronic device may be included in any one of the plurality of display devices.

According to an embodiment, a method of operating an electronic device may include receiving information related to a pixel shift operation of each of a plurality of display devices from each of the plurality of display devices.

The method may include obtaining information about an initial location of a screen and a movement of the screen to be displayed on each of the plurality of display devices, based on the information related to the pixel shift operation of each of the plurality of display devices.

The method may include transmitting the information about the initial location of the screen and the movement of the screen to each of the plurality of display devices so that each of the plurality of display devices may perform the pixel shift operation based on the information about the initial location of the screen and the movement of the screen.

The information related to the pixel shift operation of each of the plurality of display devices may include information about a pixel shift mode indicating one of a minimum distance mode for minimizing a distance between screen display locations of the plurality of display devices and an alignment mode for setting screens to be displayed at a same location on the plurality of display devices, and information about a location of each of the plurality of display devices in a display system configured based on the plurality of display devices.

The method may include determining initial locations of screens in the plurality of display devices so that the distance between the screens displayed on the plurality of display devices is minimized, based on the pixel shift mode indicating the minimum distance mode.

The method may include determining the initial location of the screen so that the screen is disposed at a right end in a display device located on the left, and determine the initial location of the screen so that the screen is disposed at a left end in a display device located on the right when the locations of the plurality of display devices are indicated as the left and the right.

The method may include determining the initial location of the screen so that the screen is disposed at a lower end in a display device disposed on the upper end, and determine the initial location of the screen so that the screen is disposed at a top end in a display device disposed on the lower end when the locations of the plurality of display devices are indicated as the upper and lower ends.

The method may include determining the initial location of the screen in each of the plurality of display devices so that the screens are displayed at a same location on the plurality of display devices, based on the pixel shift mode indicating the alignment mode.

The method may include outputting a message guiding to set pixel shift modes of the plurality of display devices to be same when the pixel shift modes of the plurality of display devices indicate different modes.

According to an embodiment, a non-transitory computer-readable recording medium storing therein one or more instructions executed by at least one processor of an electronic device, wherein the one or more instructions, when executed by the at least one processor individually and/or collectively, cause the electronic device to control a communication interface to receive information related to a pixel shift operation of each of a plurality of display devices from each of the plurality of display devices, obtain information about an initial location of a screen and a movement of the screen to be displayed on each of the plurality of display devices, based on the information related to the pixel shift operation of each of the plurality of display devices, and control the communication interface to transmit the information about the initial location of the screen and the movement of the screen to each of the plurality of display devices so that each of the plurality of display devices may perform the pixel shift operation based on the information about the initial location of the screen and the movement of the screen.

Some embodiments may also be implemented in the form of computer-readable recording media including instructions executable by computers, such as program modules executed by computers. The computer-readable recording media may be any available media accessible by computers and may include both volatile and non-volatile media and detachable and non-detachable media. In addition, the computer-readable recording media may include computer storage media. The computer storage media may include both volatile and non-volatile and detachable and non-detachable media implemented by any method or technology for storage of information such as computer-readable instructions, data structures, program modules, or other data.

The disclosed embodiments may be implemented as S/W programs including instructions stored in computer-readable storage media.

The computer may be a device capable of calling instructions stored in a storage medium and performing an operation according to the disclosed embodiment according to the called instructions and may include the electronic device according to embodiments.

The computer-readable storage medium may be provided in the form of a non-transitory storage medium. Here, “non-transitory” may indicate that the storage medium does not include a signal and is tangible, but does not distinguish semi-permanent or temporary storage of data in the storage medium.

In addition, the control method according to the disclosed embodiments may be included and provided in a computer program product. The computer program product may be traded as a product between a seller and a buyer.

The computer program product may include an S/W program and a computer-readable storage medium with the S/W program stored therein. For example, the computer program product may include products in the form of S/W programs (e.g., downloadable apps) electronically distributed through manufacturers of devices or electronic markets (e.g., Google Play Store and App Store). For electronic distribution, at least a part of the S/W program may be stored in a storage medium or may be temporarily generated. In this case, the storage medium may be a storage medium of a server of a manufacturer, a server of an electronic market, or a relay server for temporarily storing the S/W program.

In a system including a server and a device, the computer program product may include a storage medium of the server or a storage medium of the device. Alternatively, when there is a third device (e.g., a smartphone) communicatively connected to the server or the device, the computer program product may include a storage medium of the third device. Alternatively, the computer program product may include the S/W program itself that is transmitted from the server to the device or the third device or transmitted from the third device to the device.

In this case, one of the server, the device, and the third device may execute the computer program product to perform the method according to the disclosed embodiments. Alternatively, two or more of the server, the device, and the third device may execute the computer program product to perform the method according to the disclosed embodiments in a distributed manner.

For example, the server (e.g., a cloud server or an artificial intelligence server) may execute the computer program product stored in the server, to control the device communicatively connected to the server to perform the method according to the disclosed embodiments.

As another example, the third device may execute the computer program product to control the device communicatively connected to the third device to perform the method according to embodiments. When the third device executes the computer program product, the third device may download the computer program product from the server and execute the downloaded computer program product. Alternatively, the third device may perform the method according to embodiments by executing the computer program product provided in a preloaded state.

In addition, herein, the “unit” may include a hardware component such as a processor or a circuit and/or a software component executed by a hardware component such as a processor.

The foregoing descriptions are merely examples, and one of ordinary skill in the art will readily understand that various modifications may be made therein without materially departing from the spirit or features of the disclosure. Therefore, it is to be understood that embodiments described above should be considered in a descriptive sense only and not for purposes of limitation. For example, each structural element described as a single type may also be implemented in a distributed manner, and likewise, elements described as being distributed may also be implemented in a combined form.

The scope of the disclosure is defined not by the detailed description but by the following claims, and all modifications derived from the meaning and scope of the claims and equivalent concepts thereof should be construed as being included in the scope of the disclosure.

What is claimed is:

1. An electronic device comprising:
a communication interface;
memory storing one or more instructions; and
at least one processor configured to execute the one or more instructions stored in the memory,
wherein the one or more instructions, when executed by the at least one processor individually and/or collectively, cause the electronic device to:
control the communication interface to receive, from each of a plurality of display devices, information related to a pixel shift operation of the plurality of display devices;
obtain information about an initial location of a screen and a movement of the screen to be displayed on each of the plurality of display devices, based on the information related to the pixel shift operation of each of the plurality of display devices; and
control the communication interface to transmit, to each of the plurality of display devices, the information about the initial location of the screen and the movement of the screen to control each of the plurality of display devices to perform the pixel shift operation based on the initial location of the screen and the movement of the screen.

2. The electronic device of claim 1, wherein the information related to the pixel shift operation of each of the plurality of display devices comprises:
information about a pixel shift mode indicating one of a minimum distance mode for minimizing a distance between screen display locations of the plurality of display devices and an alignment mode for setting screens to be displayed at a same location on the plurality of display devices; and
information about a location of each of the plurality of display devices in a display system configured based on the plurality of display devices.

3. The electronic device of claim 2, wherein the one or more instructions, when executed by the at least one processor individually and/or collectively, cause the electronic device to, based on the pixel shift mode indicating the minimum distance mode, determine the initial location of the screen in each of the plurality of display devices so that a distance between adjacent screens displayed on the plurality of display devices is minimized.

4. The electronic device of claim 2, wherein the plurality of display devices comprises a first display device and a second display device, and
wherein the one or more instructions, when executed by the at least one processor individually and/or collectively, cause the electronic device to, based on the pixel shift mode indicating the minimum distance mode and the location of the first display device being left and the location of the second display device being right, determine the initial location of the screen as a right end of the first display device, and determine the initial location of the screen as a left end of the second display device.

5. The electronic device of claim 2, wherein the plurality of display devices comprises a first display device and a second display device, and
wherein the one or more instructions, when executed by the at least one processor individually and/or collectively, cause the electronic device to, based on the pixel shift mode indicating the minimum distance mode and the location of the first display device being top upper and the location of the second display device being bottom, determine the initial location of the screen as a lower end in the first display device, and determine the initial location of the screen as a top end in the second display device.

6. The electronic device of claim 2, wherein the one or more instructions, when executed by the at least one processor individually and/or collectively, cause the electronic device to, based on the pixel shift mode indicating the alignment mode, determine the initial location of the screen in each of the plurality of display devices so that the screens are displayed at a same location on the plurality of display devices.

7. The electronic device of claim 2, wherein the one or more instructions, when executed by the at least one processor individually and/or collectively, cause the electronic device to, based on a mismatch of the pixel shift mode of the plurality of display devices, output a message guiding to set pixel shift modes of the plurality of display devices to be same.

8. The electronic device of claim 2, wherein the information about the movement of the screen includes information about a movement direction of the screen and information about a movement range of the screen.

9. The electronic device of claim 1, wherein the communication interface comprises a wired/wireless communication interface.

10. The electronic device of claim 1, wherein the electronic device is provided in one of the plurality of display devices.

11. A method of operating an electronic device, the method comprising:
receiving, from each of a plurality of display devices, information related to a pixel shift operation of the plurality of display devices;
based on the information related to the pixel shift operation of each of the plurality of display devices, obtaining information about an initial location of a screen and a movement of the screen to be displayed on each of the plurality of display devices; and
transmitting, to each of the plurality of display devices, the information about the initial location of the screen and the movement of the screen to control each of the plurality of display devices to perform the pixel shift operation based on the initial location of the screen and the movement of the screen.

12. The method of claim 11, wherein
the information related to the pixel shift operation of each of the plurality of display devices comprises:
information about a pixel shift mode indicating one of a minimum distance mode for minimizing a distance between screen display locations of the plurality of display devices and an alignment mode for setting screens to be displayed at a same location on the plurality of display devices; and
information about a location of each of the plurality of display devices in a display system configured based on the plurality of display devices.

13. The method of claim 12, further comprising, based on the pixel shift mode indicating the minimum distance mode, determining the initial location of the screen in each of the plurality of display devices so that a distance between adjacent screens displayed on the plurality of display devices is minimized.

14. The method of claim 12, wherein the plurality of display devices comprises a first display device and a second display device, and
wherein the method further comprises, based on the pixel shift mode indicating the minimum distance mode and the location of the first display device being left and the location of the second display device being right, determining the initial location of the screen as a right end of the first display device, and determining the initial location of the screen as a left end of the second display device.

15. The method of claim 12, wherein the plurality of display devices comprises a first display device and a second display device, and
wherein the method further comprises, based on the pixel shift mode indicating the minimum distance mode and the location of the first display device being bottom, determining the initial location of the screen as a lower end in the first display device, and determining the initial location of the screen as a top end in the second display device.

16. The method of claim 12, further comprising, based on the pixel shift mode indicating the alignment mode, determining the initial location of the screen in each of the plurality of display devices so that the screens are displayed at a same location on the plurality of display devices.

17. The method of claim 12, further comprising, based on a mismatch of the pixel shift mode of the plurality of display devices, outputting a message guiding to set pixel shift modes of the plurality of display devices to be same.

18. The method of claim 12, wherein the information about the movement of the screen includes information about a movement direction of the screen and information about a movement range of the screen.

19. A non-transitory computer-readable recording medium storing therein one or more instructions executable by at least one processor of an electronic device, wherein the one or more instructions, when executed by the at least one processor of the electronic device, cause the electronic device to:
control a communication interface to receive, from each of a plurality of display devices, information related to a pixel shift operation of the plurality of display devices;
obtain information about an initial location of a screen and a movement of the screen to be displayed on each of the plurality of display devices, based on the information related to the pixel shift operation of each of the plurality of display devices; and
control the communication interface to transmit, to each of the plurality of display devices, the information about the initial location of the screen and the movement of the screen to control each of the plurality of display devices to perform the pixel shift operation based on the initial location of the screen and the movement of the screen.
